(19) United States
(12) Patent Application Publication
(10) Pub. No.: US 2024/0412083 A1
(43) Pub. Date: Dec. 12, 2024

(54) MODULAR AND CONFIGURABLE COMPUTATIONAL FRAMEWORKS FOR REAL-TIME INFERENCING IN DISTRIBUTED COMPUTING ENVIRONMENTS

(71) Applicant: The Toronto-Dominion Bank, Toronto (CA)

(72) Inventors: Peter Starszyk, Waterloo (CA); Xiaochen Zhang, Toronto (CA); Devinder Kumar, Toronto (CA); Darren Andrew Pepper, Toronto (CA)

(21) Appl. No.: 18/208,032

(22) Filed: Jun. 9, 2023

(51) Int. Cl. G06N 5/04

(52) U.S. Cl. CPC G06N 5/04

(57) ABSTRACT

The disclosed embodiments include modular and configurable computer-implemented processes and systems that facilitate real-time inferencing in distributed computing environments. For example, an apparatus may receive a real-time inferencing request from a computing system, and, based on the inferencing request, the apparatus may obtain configuration data associated with a trained machine-learning process. The apparatus may also perform operations that (i) generate the input dataset based on an application of one or more feature-engineering operations to the elements of payload data in accordance with a first portion of the configuration data, and (ii) generate output data based on the application, in real-time, of the trained machine-learning process to the input dataset. The apparatus may transmit, to the computing system, a response to the real-time inferencing request that includes at least at least a portion of the output data.

### TECHNICAL FIELD

The disclosed embodiments generally relate to modular and configurable computer-implemented processes that facilitate real-time inferencing in distributed computing environments.

### BACKGROUND

Machine-learning and artificial-intelligence processes are widely adopted throughout various industries, and an output of these machine learning and artificial intelligence process may inform decisions associated with a targeted marketing of products and services to existing and prospective customers of these industries, or a suspiciousness of certain activities performed by these existing and prospective customers of these industries. By way of example, an organization may include multiple business units, and each of the business units may develop, adaptively train, and then deploy, one or more trained artificial intelligence or machine learning processes that generate elements of output data consistent with the needs of that business unit and on a schedule appropriate to those needs.

### SUMMARY

In some examples, an apparatus includes a communications interface, a memory storing instructions, and at least one processor coupled to the communications interface and to the memory. The at least one processor is configured to execute the instructions to receive an inferencing request from a computing system via the communications interface. The inferencing request includes elements of payload data, and the inferencing request is associated with an application, in real-time, of a trained machine-learning or artificial intelligence process to an input dataset. The at least one processor is further configured to execute the instructions to, based on the inferencing request, obtain configuration data associated with the trained machine-learning or artificial intelligence process. The configuration data is generated by the computing system, and the at least one processor is further configured to perform operations that (i) generate the input dataset based on an application of one or more feature-engineering operations to the elements of payload data in accordance with a first portion of the configuration data, and (ii) generate output data based on the application, in real-time, of the trained machine-learning or artificial intelligence process to the input dataset. The at least one processor is further configured to transmit, to the computing system via the communications interface, a response to the inferencing request that includes at least at least a portion of the output data.

In other examples, a computer-implemented method includes receiving an inferencing request from a computing system using at least one processor. The inferencing request includes elements of payload data, and the inferencing request is associated with an application, in real-time, of a trained machine-learning or artificial intelligence process to an input dataset. The computer-implemented method also includes, based on the inferencing request, obtaining, using the at least one processor, configuration data associated with the trained machine-learning or artificial intelligence process. The configuration data is generated by the computing system and the computer-implemented method also includes performing operations, using the at least one processor, that (i) generate the input dataset based on an application of one or more feature-engineering operations to the elements of payload data in accordance with a first portion of the configuration data, and (ii) generate output data based on the application, in real-time, of the trained machine-learning or artificial intelligence process to the input dataset. The computer-implemented method also includes transmitting, using the at least one processor, and to the computing system, a response to the inferencing request that includes at least at least a portion of the output data.

Further, in some examples, a tangible, non-transitory computer-readable medium storing instructions that, when executed by at least one processor, causes the at least one processor to perform a method that includes receiving an inferencing request from a computing system. The inferencing request includes elements of payload data, and the inferencing request is associated with an application, in real-time, of a trained machine-learning or artificial intelligence process to an input dataset. The method also includes, based on the inferencing request, obtaining configuration data associated with the trained machine-learning or artificial intelligence process. The configuration data is generated by the computing system, and the method also includes performing operations that (i) generate the input dataset based on an application of one or more feature-engineering operations to the elements of payload data in accordance with the configuration data, and (ii) generate output data based on the application, in real-time, of the trained machine-learning or artificial intelligence process to the input dataset. The method also includes transmitting, to the computing system, a response to the inferencing request that includes at least at least a portion of the output data.

The details of one or more exemplary embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIGS. 1, 2A, 2B, and 3A-3C are block diagrams illustrating portions of an exemplary computing environment, in accordance with some exemplary embodiments.

FIG. 4 is a flowchart of an exemplary process for customizing a sequential, pipelined execution of real-time inferencing processes within a distributed computing environment, in accordance with some embodiments.

FIG. 5 is a flowchart of an exemplary process for executing pipelined, real-time inferencing processes within a distributed computing environment, in accordance with some embodiments.

Like reference numbers and designations in the various drawings indicate like elements.

### DETAILED DESCRIPTION

Today, many organizations, such as financial institutions, rely on a predicted output of machine-learning and artificial-intelligence processes to inform a variety of decisions and strategies. By way of example, a financial institution may obtain elements of customer-specific, predicted output generated through an application of one or more trained machine-learning or artificial-intelligence processes, and the obtained elements of predicted, customer-specific output may inform, among other things, customer-specific strategies for mitigating or managing risk, decisions related to a suspiciousness of certain activities performed by these existing and prospective customers, or collection strategies involving one or more existing customers of the financial institution. Further, in some examples, the financial institution may also rely on the elements of customer-specific predicted output to inform decisions associated with the provisioning of financial products or services to existing or prospective customers of the financial institution, decisions associated with a requested modification to a term of condition of a provisioned financial product or service, or decisions associated with a targeted marketing of products and services to existing and prospective customers.

In some instances, each of the trained machine-learning and artificial-intelligence processes may be associated with a corresponding, process-specific input dataset, each of which may include a plurality of sequentially ordered, process-specific input features and corresponding, customer-specific feature values, and with corresponding process-specific schedules for a delivery of corresponding elements of predicted output to a corresponding computing system. Further, each of the trained machine-learning or artificial-intelligence processes may also be associated with a plurality of sequential data-pipelining operations that, when executed by one or more computing systems associated with, or operated by, the financial institution, facilitate a generation of corresponding ones of the process-specific input datasets based on an application of one or more process-specific, feature-engineering operations to elements of confidential data characterizing customers of the financial institution, an ingestion of the process-specific input datasets by corresponding ones of the trained machine-learning or artificial-intelligence processes, and a generation of the elements of predictive output, in accordance with the underlying, process-specific delivery schedule (e.g., at an expected delivery time on a daily basis, a weekly basis, a bi-monthly basis, or on a monthly basis).

Each of the process-specific input datasets may, for example, include sequentially ordered feature values derived from elements of confidential data characterizing hundreds, if not thousands, of the customers of the financial institution. Further, and to facilitate a delivery of the predicted output in accordance with the process-specific delivery schedules, the one or more computing systems associated with, or operated by, the financial institution may implement batch processing to execute the process-specific data-pipelining operations described, which may generate the process-specific input datasets based on the application of the corresponding feature-engineering operations to elements of confidential data characterizing the hundreds, or thousands, of customers of the financial institution, and generate the elements of the predicted output based on the application the trained machine-learning or artificial-intelligence processes to corresponding ones of the process-specific input datasets.

In some instances, the batch-based execution of the process-specific data-pipelining operations may rely on static, hard-coded scripts or executable application modules that establish not only the sequential execution of discrete ones of the process-specific data pipelining operations, but that also establish, in a static and inflexible form, one or more process-specific, data pre-processing operations, corresponding ones of the process-specific feature-engineering operations, values of parameters characterizing corresponding ones of the trained machine-learning or artificial-intelligence processes and additionally, or alternatively, one or more process-specific, post-processing operations. These hard-coded scripts or executable application modules, when executed by the one or more computing systems associated with, or operated by, the financial institution, may facilitate the batch-based execution of each of the process-specific data pipelining operations and the provisioning of the elements of the predicted output to the computing systems of corresponding business units of the financial institution in accordance with the process-specific delivery schedules.

While facilitating a provisioning of elements of the predicted output in accordance with the predetermined, and process-specific, delivery schedules, the static, hard-coded scripts or executable application modules that support these batch-based operations may be incapable of supporting a transition from pre-scheduled inferencing to real-time inferencing on a request-by-request, and customer-by-customer, basis. For example, the one or more computing systems associated with or operated by the financial institution may receive, from a requesting computing system, a real-time inferencing request for elements of predictive output supporting, among other things, a decision in real-time to increase a credit-limit associated with a provisioned, unsecured lending product, a decision in real-time to pre-approve an application for a secured or unsecured lending product, and additionally, or alternatively, a determination in real-time that an initiated transaction represents an instance of potentially fraudulent activity (e.g., based on an application, in real-time, of a trained machine-learning or artificial-intelligence process to a corresponding, process-specific input dataset). In some instances, the batch-based processes, which facilitate a delivery of predicted output data in accordance with the predetermined, and process-specific delivery schedules, may be incapable of servicing these real-time inferencing requests, and applying in real-time the trained machine-learning or artificial-intelligence processes to the corresponding, process-specific input datasets, without significant, and request-specific, modifications to the static, hard-coded scripts or executable application modules.

In some instances, described herein, the one or more computing systems of the financial institution may execute a generalized, modular and configurable, computational framework that, when accessed by a requesting computing system through a programmatic interface, facilitates a real-time application of a trained machine-learning or artificial-intelligence process to an input dataset consistent with one or more customized feature-engineering operations without modification to underlying elements of coding that support the execution of the computational framework. By way of example, the computational framework may include a plurality of discrete, executable application modules which, when executed by the one or more computing systems of the financial institution, facilitate the real-time application of the trained machine-learning or artificial-intelligence process to the input dataset. The plurality of discrete, executable application modules may, for example, be associated with corresponding, executable module-specific scripts that establish a sequential order in which the executed application modules performs operations on elements of input data and generate output data. As described herein, each of the executable, module-specific scripts may be maintained in Python™ format and in a portion of a data repository (e.g., within a secure partition of a Hadoop™ distributed file system (HDFS)) that is inaccessible to the requesting computing system.

Further, each of the executable application modules may also be associated with elements of module-specific configuration data, such as, but not limited to, a module-specific configuration files maintained within a portion of a data repository (e.g., an additional partition of the HDFS, etc.) accessible to the requesting computing system. By way of example, each of the elements of module-specific configuration data may be structured and formatted in a human-readable data-serialization language, such as, but not limited to, a YAML™ data-serialization language or an extensible markup language (XML). In some instances, and using any of the exemplary processes described herein, the requesting computing system may perform operations that access one or more elements of the module-specific configuration data associated with a corresponding one of the executable application modules (e.g., as maintained by the computing systems of the financial institution), and may customize the accessed elements (or generate additional elements) of the module-specific configuration data to specify, among other things, one or more objects, one or more functions (e.g., in helper scripts callable in a namespace of the corresponding, executable application module, such as, but not limited to, in support of one or more customized data pre-processing and/or feature-engineering operations, etc.), parameters of the functions (e.g., inputs and outputs, values of parameters of the trained machine-learning or artificial-intelligence processes specified by the client computing system, etc.), elements of data that specifies a sequential or concurrent execution of subsets of the functions, and/or data specifying a format or composition of a final output of the corresponding, executable application module.

As described herein, the one or more computing systems of the financial institution may perform operations that initiate a sequential, pipelined execution of each, or a selected subset, of the application modules in accordance with respective ones of the static, module-specific scripts, and further, in accordance with respective, and customized, elements of the module-specific configuration data. Through the sequential, pipelined execution of the application modules, the one or more computing systems of the financial institution may ingest and pre-process of elements of confidential, customer data specified by the requesting computing system, generate an input dataset consistent with one or more feature-engineering operations specified or customized by the requesting computing system, and based on a real-time application of a trained machine-learning or artificial-intelligence process to the input dataset, generate predictive output and provisioning that predictive output to the requesting computing system in real-time and contemporaneously with a receipt of a corresponding real-time inferencing request, and without modification to the static, module-specific scripts. Certain of the exemplary processes described herein, which provide a generalized, modular and configurable computational framework described herein the executes real-time inferencing processes without modification to elements of executable code supporting the computational framework, may be implemented in addition to, or as an alternative to, the batch-based processes described herein, which rely static, hard-coded scripts or executable application modules and provision process-specific elements of predictive output not in real-time, but in accordance with the underlying, predetermined and process-specific delivery schedules.

### A. Exemplary Computing Environments

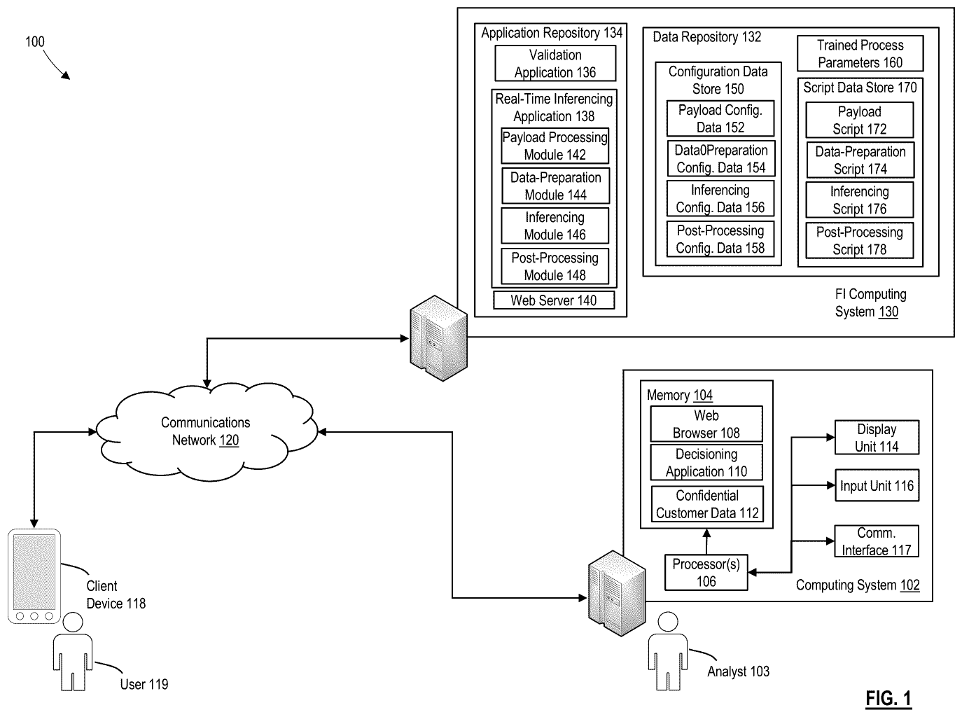

FIG. 1 illustrates an exemplary computing environment 100 that includes, among other things, one or more computing systems, such as a computing system 102 and a financial institution (FI) system 130, and one or more computing devices, such as client device 118. Each of the computing systems, including computing system 102 and FI computing system 130, and each of the computing devices, such as client device 118, may be operatively connected to, and interconnected across, one or more communications networks, such as communications network 120. Examples of communications network 120 include, but are not limited to, a wireless local area network (LAN) (e.g., a “Wi-Fi” network), a network utilizing radio-frequency (RF) communication protocols, a Near Field Communication (NFC) network, a wireless Metropolitan Area Network (MAN) connecting multiple wireless LANs, and a wide area network (WAN) (e.g., the Internet).

In some instances, computing system 102 may be associated with, or operated by, a corresponding business or organizational unit of the financial institution, and computing system 102 may include a computing system or device having one or more tangible, non-transitory memories, such as memory 104, that store data and/or software instructions, and one or more processors, such as, processor(s) 106, configured to execute the software instructions. As illustrated in FIG. 1, memory 104 may store one or more software applications, application modules, and other elements of code executable by one or more processor(s) 106, such as, but not limited to, an executable web browser 108 (e.g., Google Chrome™, Apple Safari™, etc.) capable of interacting with one or more web servers established programmatically by FI computing system 130, an executable decisioning application 110, and additionally or alternatively, an executable application associated with or provisioned by FI computing system 130. In some instances, memory 104 may also include one or more structured or unstructured data repositories or databases, and computing system 102 may maintain, within the structured or unstructured data repositories of memory 104, one or more elements of confidential customer data 112 that identify and characterize one or more customers of the financial institution, interactions between these customers and the financial institution (and other, unrelated financial institution), and a use, or misuse, of one or more financial or payment products provisioned to these customers by the financial institution or by the unrelated financial institutions, such as, but not limited to, elements of customer profile data, account data, transaction data, and credit-bureau data.

Computing system 102 may also include a display unit 114 configured to present interface elements to a corresponding user, such as analyst 103, and an input unit 116 configured to receive input from analyst 103, e.g., in response to the interface elements presented through display unit 114. By way of example, display unit 114 may include, but is not limited to, an LCD display unit or other appropriate type of display unit, and input unit 116 may include, but is not limited to, a keypad, keyboard, touchscreen, voice activated control technologies, or appropriate type of input unit. Further, in additional aspects (not illustrated in FIG. 1), the functionalities of display unit 114 and input unit 116 may be combined into a single device, such as, a pressure-sensitive touchscreen display unit that presents interface elements and receives input from the user of computing system 102, such as analyst 103. Computing system 102 may also include a communications interface 117, such as a wireless transceiver device, coupled to processor(s) 106 and configured by processor(s) 106 to establish and maintain communications with communications network 120 via one or more communication protocols, such as WiFi®, Bluetooth®, NFC, a cellular communications protocol (e.g., LTER, CDMA®, GSM®, etc.), or any other suitable communications protocol.

Examples of computing system 102 may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on an interface device or unit, such as display unit 114. In some instances, computing system 102 may also establish communications with one or more additional computing systems or devices operating within computing environment 100 across a wired or wireless communications channel (via the communications interface 117 using any appropriate communications protocol). Further, a user, such as an analyst 103, may operate computing system 102 and may do so to cause computing system 102 to perform one or more exemplary processes described herein.

In some instances, client device 118 may be associated with, or operable by, an existing or prospective customer of the financial institution, such as user 119, and client device 118 may include a computing system or device having one or more tangible, non-transitory memories that store data and/or software instructions, and one or more processors configured to execute the software instructions. The one or more tangible, non-transitory memories of client device 118 may store one or more software applications, application modules, and other elements of code executable by the one or more processors, such as, but not limited to, an executable web browser (e.g., Google Chrome™, Apple Safari™, etc.), and additionally or alternatively, an executable application associated with or provisioned by FI computing system 130, such as a mobile banking application. Further, although not illustrated in FIG. 1, client device 118 may also include a display unit configured to present interface elements to a corresponding user, such as user 119, an input unit configured to receive input from user 119 (e.g., in response to the interface elements presented through the display unit), and a communications interface, such as a wireless transceiver device, coupled to the one or more processors and configured by the one or more processors to establish and maintain communications with communications network 120 via one or more communication protocols, such as those described herein.

Examples of client device 118 may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on an interface device or unit, such as the display unit. In some instances, client device 118 may also establish communications with one or more additional computing systems or devices operating within computing environment 100 across a wired or wireless communications channel (via the communications interface using any appropriate communications protocol).

In some examples, FI computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operations) in a single clock cycle. Further, FI computing system 130 may also include a communications interface, such as one or more wireless transceivers, coupled to the one or more processors for accommodating wired or wireless internet communication with other computing systems and devices operating within computing environment 100.

Further, in some instances, FI computing system 130 may correspond to a distributed computing system having a plurality of interconnected, computing components distributed across an appropriate computing network, such as communications network 120 of FIG. 1. For example, FI computing system 130 may correspond to a distributed or cloud-based computing cluster associated with, and maintained by, the financial institution, although in other examples, FI computing system 130 may correspond, respectively, to a publicly accessible, distributed or cloud-based computing cluster, such as a computing cluster maintained by Microsoft Azure™, Amazon Web Services™, Google Cloud™, or another third-party provider.

For example, each of FI computing system 130 may include a corresponding plurality of interconnected, distributed computing components, such as those described herein (not illustrated in FIG. 1), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of FI computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Through an implementation of the parallelized, fault-tolerant distributed computing and analytical protocols described herein, the distributed computing components of FI computing system 130 may perform operations, described herein, to implement a generalized, modular and configurable computational framework that facilitates a real-time application of a trained machine-learning or artificial-intelligence process to an input dataset consistent with one or more feature-engineering operations specified by computing system 102 and having discrete feature values derived from elements of confidential customer data provisioned by computing system 102, and further, that facilitates a real-time generation of elements of predictive output having a format or composition specified by computing system 102, without requiring modification, by computing system 102, to underlying elements of code associated with, and that support, the generalized, modular and configurable computational framework. The implementation of the parallelized, fault-tolerant distributed computing and analytical protocols described herein across the one or more GPUs or TPUs included within the distributed computing components of FI computing system 130 may, in some instances, accelerate the deployment of machine-learning and artificial-intelligence processes when compared to a deployment of the machine-learning and artificial-intelligence processes across comparable clusters of CPUs capable of processing a single operation per clock cycle.

In some instances, one or more distributed computing components of FI computing system 130 may perform one or more of the exemplary processes described herein to execute sequentially one or more application modules within the generalized, modular and configurable computational framework, in accordance with corresponding static module-specific scripts, and further, in accordance with corresponding elements of module-specific configuration data generated by, or customized by, computing system 102. By way of example, the sequentially executed application modules may perform operations, described herein, that apply one or more data pre-processing operations to elements of payload data maintained within a real-time inferencing request received from computing system 102, that generate, in real-time, an input dataset based on an application of one or more feature-engineering operations specified by computing system 102 to the elements of payload data, that apply a trained, machine-learning or artificial intelligence process specified by computing system 102 to the input dataset, and that generate, in real-time, elements of predicted output data having a format and composition specified by computing system 102. Through a performance of these exemplary processes, the generalized, modular and configurable computational framework established by the distributed computing components of FI computing system 130 may provision, to computing system 102, a response that includes the elements of predicted output in real-time and contemporaneously with a receipt of the real-time inferencing request from computing system 102, and without any modification to the executable code of the application modules, or to the static module-specific scripts, by computing system 102.

To facilitate a performance of one or more of these exemplary processes, FI computing system 130 may maintain, within the one or more tangible, non-transitory memories, a data repository 132 that includes a configuration data store 150, one or more elements of trained process parameters 160, a script data store 170. Further, and to facilitate a performance of one or more of these exemplary processes, FI computing system 130 may maintain, within the one or more tangible, non-transitory memories, an application repository 134 that includes an executable validation application 136, an executable, real-time inferencing application 138, and a programmatic web server 140, each of which may be executed by the one or more processors of FI computing system 130 (e.g., by the distributed computing components of FI computing system 130).

In some instances, when executed by the one or more processors of FI computing system 130, validation application 136 may receive a real-time inferencing request generated by computing system 102 (e.g., via a corresponding programmatic interface, such as a validation application programming interface (API)), and may perform any of the exemplary processes described herein to validate the real-time inferencing request based on, among other things, a determination that a source of the inferencing request (e.g., computing system 102) is permitted to request real-time inferencing, and additionally, or alternatively, a determination that the requested real-time inferencing is within the scope of a trained machine-learning or artificial intelligence process available at FI computing system 130. Further, and responsive to a successful validation of the real-time inferencing request, the executed validation application 136 may also perform operations, described herein, that append elements of validation data to the real-time inferencing request confirming the successful validation.

Further, in some instances, real-time inferencing application 138 may include a plurality of executable application modules, such as, but not limited to, executable payload processing module 142, executable data-preparation module 144, executable inferencing module 146, and executable post-processing module 148. As described herein, each of executable payload processing module 142, executable data-preparation module 144, executable inferencing module 146, and executable post-processing module 148 may be associated with an element of module-specific configuration data maintained within configuration data store 150, such as, but not limited to, a corresponding element of payload configuration data 152, data-preparation configuration data 154, inferencing configuration data 156, and post-processing configuration data 158. Additionally, and as described herein, each of executable payload processing module 142, executable data-preparation module 144, executable inferencing module 146, and executable post-processing module 148 may also be associated with a static, module-specific script maintained within script data store 170, such as, but not limited to, a corresponding one of payload script 172, data-preparation script 174, inferencing script 176, and post-processing script 178.

In some instances, FI computing system 130 may maintain each of payload configuration data 152, data-preparation configuration data 154, inferencing configuration data 156, and post-processing configuration data 158 within a portion of data repository 132 that is accessible across communications network 120 by one or more of application programs executed by computing system 102 (e.g., within an accessible partition of a Hadoop™ distributed file system, etc.). As described herein, the elements of payload configuration data 152, data-preparation configuration data 154, inferencing configuration data 156, and post-processing configuration data 158 may be structured and formatted in a Python™-compatible, human-readable data-serialization language, such as, but not limited to, a YAML™ data-serialization language. Further, computing system 102 may perform any of the exemplary processes described herein to generate, or to access and modify, one or more of payload configuration data 152, data-preparation configuration data 154, inferencing configuration data 156, and post-processing configuration data 158, e.g., via a secure, programmatic channel of communications established by one or more application programs, such as web browser 108 and based on input data provisioned by analyst 103 to input unit 116.

Further, each of the elements of payload configuration data 152, data-preparation configuration data 154, inferencing configuration data 156, and post-processing configuration data 158 may define or identify one or more data objects, one or more functions or operations (e.g., in “helper” scripts callable in a namespace of a corresponding one of executable payload processing module 142, executable data-preparation module 144, executable inferencing module 146, and executable post-processing module 148), and a value of one or more parameters of the defined or identified functions or operations, including parameter values characterizing a sequential or parallel execution of the defined or identified functions or operations (e.g., via corresponding ones of the helper scripts, etc.) and additionally, or alternatively, a format, composition, or structure of output data generated by the corresponding one of executable payload processing module 142, executable data-preparation module 144, executable inferencing module 146, and executable post-processing module 148.

In some instances, one or more of the identified and defined objects, functions or operations, parameters values, and/or the format, composition, or structure of the output data maintained within the elements of payload configuration data 152, data-preparation configuration data 154, inferencing configuration data 156, and post-processing configuration data 158 may be generated, or customized, by computing system 102 using any of the exemplary processes described herein. Additionally, or alternatively, the elements of one or more of payload configuration data 152, data-preparation configuration data 154, inferencing configuration data 156, and post-processing configuration data 158 may a corresponding default object, a default function or operation, a default parameter value, a default format, composition, or structure of the corresponding output data, which may be established by FI computing system 130, and which may be subject to future customization or modification by computing system 102 using any of the exemplary processes described herein.

Further, the static, module-specific scripts within script data store 170, including payload script 172, data-preparation script 174, inferencing script 176, and post-processing script 178, may be maintained, or coded, in a Python™ format, and FI computing system 130 may store each of the static, module-specific scripts within a portion of data repository 132 that is inaccessible to the one or more of application programs executed by computing system 102 (e.g., within an inaccessible partition of a Hadoop™ distributed file system, etc.). In some instances, payload script 172, data-preparation script 174, inferencing script 176, and post-processing script 178 may facilitate an execution, within the generalized, modular computational framework, of a corresponding one of payload processing module 142, data-preparation module 144, inferencing module 146, and post-processing module 148 in accordance with respective ones of payload configuration data 152, data-preparation configuration data 154, inferencing configuration data 156, and post-processing configuration data 158.

By way of example, payload configuration data 152 may be associated with, and accessible to and interpretable by, payload processing module 142 (e.g., in accordance with payload script 172), and the elements of payload configuration data 152 may include, among other things, data identifying a composition and/or a structure of the payload data included within the received, real-time inferencing request. As described herein, the payload data may include elements of structured confidential data maintained within multiple, nested data tables (e.g., formatted in a standardized data-exchange format, such as JSON™), and in some instances, payload configuration data 152 may specify a structure of the nested data tables within the payload data, including a hierarchical relationship between groups of the nested data tables and additionally, or alternatively, one or more primary key indices across the nested data tables.

In some instances, payload configuration data 152 may also include data that identifies, or defines, one or more data pre-processing operations performed by executed payload processing module 142, such as, but not limited to, data pre-processing operations that confirm the nested data tables within the payload data include the primary key indices, that “flatten” the nested, structured data tables within the payload data, that generate elements of data (e.g., a Python™ structured dictionary or other associative array, etc.) indexing the flattened tabular data in accordance with corresponding primary key indices, and that generate structured and indexed, output data that include the flattened tabular data and in some instances, the indexing data, the and that include the dictionary data. Further, the elements of payload configuration data 152 may also include data that characterizes the sequential execution of these data-preprocessing operations, and that specifies a composition of the flattened and indexed output data (including the elements of indexing data).

As described herein, data-preparation configuration data 154 may be associated with, and accessible to and interpretable by, data-preparation module 144 upon execution by real-time inferencing application 138 (e.g., in accordance with data-preparation script 174). In some instances, the elements of data-preparation configuration data 154 may include, among other things, data identifying the plurality of features of the input dataset and a sequential position of each of the features within the input dataset (e.g., as specified by computing system 102 using any of the exemplary processes described herein), data identifying one or more feature-engineering operations (e.g., as specified by computing system 102) that, when applied to the elements of flattened and indexed output data by executed data-preparation module 144, generate, compute, or derive corresponding ones of the of the feature values, and parameter values that characterize one or more of the feature-engineering operations, and data characterizing an order of sequential, or parallel, application of the feature-engineering operations to the elements of flattened and indexed output data during the generation, computation, or derivation of corresponding ones of the feature values.

By way of example, the feature-engineering operations specified within data-preparation configuration data 154 for a corresponding feature (e.g., an average or maximum account balance for unsecured credit products, etc.) may include one or more aggregation operation associated with corresponding elements of customer account data (e.g., balances of unsecured credit products, etc.) during a prior, temporal interval (e.g., three months), and the data-preparation configuration data 154 may include a corresponding operation identifier for the aggregation operation (e.g., an average, a maximum, etc.), the prior temporal interval (e.g., three months, etc.), and an identifier of the feature and the corresponding element of customer account data (e.g., account balance of unsecured credit products, etc.), and data characterizing an order of sequential or parallel application of the one or more aggregation operation to the elements of flattened and indexed output data. In some instances, the elements of data-preparation configuration data 154 may also include data characterizing a structure or format of the input dataset of generated, computed, or derived feature values, such as, but not limited to, the Python™-compatible pandas dataframe described herein.

Further, inferencing configuration data 156 may be associated with, and accessible to and interpretable by, inferencing module 146 upon execution by real-time inferencing application 138 (e.g., in accordance with inferencing script 176). The elements of inferencing configuration data 156 may include an identifier of a trained machine-learning or artificial-intelligence process available for application to the input dataset generated by executed data-preparation module 144 (e.g., an alphanumeric identifier of a trained, gradient-boosted, decision-tree process, such as a trained XGBoost process). Further, in some instances, the elements of inferencing configuration data 156 may specify, among other things, a structure or format of the elements of predictive output data (e.g., alphanumeric output data, integer values, or floating-point values, etc.), and a structure or format of elements of explainability data (e.g., as an output file having a corresponding file format accessible at computing system 102, such as a PDF or a DOCX file).

In some instances, described herein, trained process parameters 160 may include one or more elements that include, or reference, the identifier of the trained machine-learning or artificial-intelligence process maintained within the elements of inferencing configuration data 156, By way of example, the elements of trained process parameters 160 that include the alphanumeric identifier of the trained, gradient-boosted, decision-tree process described herein may also specify a value of one or more process parameters that characterize the trained, gradient-boosted, decision-tree process (e.g., the trained, XGBoost process), such as, but not limited to, a learning rate associated with the trained, gradient-boosted, decision-tree process, a number of discrete decision trees included within the trained, gradient-boosted, decision-tree process (e.g., the “n_estimator” for the trained, gradient-boosted, decision-tree process), a tree depth characterizing a depth of each of the discrete decision trees included within the trained, gradient-boosted, decision-tree process, a minimum number of observations in terminal nodes of the decision trees, and/or values of one or more hyperparameters that reduce potential model overfitting (e.g., regularization of pseudo-regularization hyperparameters).

Further, post-processing configuration data 158 may be associated with, and accessible to and interpretable by, post-processing module 148 upon execution by real-time inferencing application 138, e.g., in accordance with post-processing script 178. In some instances, the elements of post-processing configuration data 158 may include, among other things, data identifying or defining one or more post-processing operations applied to elements of predictive output, or to elements of explainability data by executed post-processing module 148, and data characterizing an order of sequential, or parallel, application of the post-processing operations to the elements of predictive output, or to elements of explainability data.

The one or more post-processing operations may include, among other things, an application of one or more “one-hot” encoding operations to alphanumeric character strings within the elements of predictive output data maintained within the inferencing output data, and an application one or more scaling operations to integer or floating-point values within the elements of predictive output date or the elements of explainability data maintained within the inferencing output data. The one or more post-processing operations may include, among other things, processes that generate one or more “reason codes” for the elements of predictive output data based on portions of the explainability data (e.g., identifiers of a predetermined number of features characterized by maximum Shapley feature values, etc.), and further, processes, described herein, to generate inferencing logs associated with the execution of real-time inferencing application 138 and the generation of the elements of predictive inferencing output based on the sequential execution of payload processing module 142, data-preparation module 144, inferencing module 146, and post-processing module 148. Further, the elements of post-processing configuration data 158 may also include data specifying a composition, structure, or format of a response to a real-time inferencing request, which may include, among other things elements of post-processed predictive output and/or elements of post-processed explainability data. In some examples, described herein, the one or more processors of FI computing system 130, which may establish collectively a distributed computing cluster across communications network 120, may establish and maintain a validation API, which may perform any of the exemplary processes described herein to parse portions of the real-time inferencing request (including the payload data) received by FI computing system 130 and determine a source and scope of the real-time inferencing request. The one or more processors of FI computing system 130 may also execute validation application 136, which may perform any of the exemplary processes described herein to validate the real-time inferencing request based on a determination that the source of the inferencing request is permitted to request real-time inferencing, and that the requested real-time inferencing is within the scope of a trained machine-learning or artificial intelligence process available at FI computing system 130.

Further, the one or more processors of FI computing system 130 may also execute real-time inferencing application 138, which may perform operations, consistent with corresponding ones of payload script 172, data-preparation script 174, inferencing script 176, and post-processing script 178, that execute sequentially, within the generalized, modular computational framework, each of payload processing module 142, data-preparation module 144, inferencing module 146, and post-processing module 148 in accordance with corresponding elements of payload configuration data 152, data-preparation configuration data 154, inferencing configuration data 156, and post-processing configuration data 158. As described herein, the sequential execution of each of payload processing module 142, data-preparation module 144, inferencing module 146, and post-processing module 148 by the one or more processors of FI computing system 130 may perform operations, described herein, that apply one or more data pre-processing operations to elements of payload data maintained within a real-time inferencing request received from computing system 102, that generate, in real-time, an input dataset based on an application of one or more feature-engineering operations specified by computing system 102 to the elements of payload data, that apply a trained, machine-learning or artificial intelligence process specified by computing system 102 to the input dataset, and that generate, in real-time, elements of predicted output data having a format and composition specified by computing system 102.

In other examples, the receipt of the real-time inferencing request at FI computing system 130 may trigger an execution, by the one or more processors of FI computing system 130, of programmatic web server 140 (e.g., a Python™-based, Gunicorn™ web server, etc.) and executed programmatic web server 140 may establish a programmatic web service that established and maintains the validation API described herein, and further, establishes a corresponding web framework (e.g., a Python-based Flask™ micro web framework) that executes validation application 136, e.g., to perform any of the exemplary validation processes described herein. Further, in some examples, the programmatic web service established by executed programmatic web server 140 may also perform operations that establish and maintain the real-time inferencing API described herein, and the corresponding web framework may execute real-time inferencing application 138 and perform operations that orchestrate the sequential execution, consistent with corresponding ones of payload script 172, data-preparation script 174, inferencing script 176, and post-processing script 178, of each of payload processing module 142, data-preparation module 144, inferencing module 146, and post-processing module 148 in accordance with corresponding ones of payload configuration data 152, data-preparation configuration data 154, inferencing configuration data 156, and post-processing configuration data 158.

B. Exemplary Processes for Executing Configurable, Pipelined, Real-Time Inferencing Processes within a Distributed Computing Environment

In some instances, one or more distributed computing components of FI computing system 130 may perform operations, described herein, to implement sequentially a plurality of discrete, data pipelining operations that facilitate an application of a trained machine-learning or artificial intelligence process to an input dataset consistent with one or more feature-engineering operations customized by a business unit of the financial institution, and a delivery of transformed elements of predictive output having a format or structure customized by the business unit, in real-time and in response to an inferencing request generated by a computing system or device operable by the business unit. By way of example, each of the plurality of discrete, data pipelining operations may be associated with a corresponding, executable application module, which may be executed sequentially by the one or more distributed computing components of FI computing system 130 in accordance with corresponding, static module-specific scripts.

Further, in some instances, each of the executable application modules may be associated with corresponding elements of configuration data, and the elements of configuration data may, for each of the executable application modules, define or identify one or more data objects, one or more functions or operations (e.g., in “helper” scripts callable in a namespace of a corresponding one of the executable application module), a value of one or more parameters of the defined or identified functions or operations, including parameter values characterizing a sequential or parallel execution of the defined or identified functions or operations (e.g., via corresponding ones of the helper scripts, etc.) and additionally, or alternatively, a format, composition, or structure of output data generated by the executable application module. As described herein, the computing system operable by the business unit, such as computing system 102 of FIG. 1, may establish a secure programmatic channel of communications across communications network 120 with the one or more distributed computing components of FI computing system 130, and may perform operations that access one or more of the elements of configuration data and further, that modify or update the accessed elements of configuration data to reflect one or more pre-processing, feature-engineering, inferencing, or post-processing operations requested in real-time by the business unit.

Through a modification of one or more of the module-specific elements of configuration data to reflect the one or more requested pre-processing, feature-engineering, inferencing, or post-processing operations, certain of the exemplary processes described herein enable computing system 102 to customize the sequential, pipelined execution of the application modules and receive, in real-time, transformed elements of predictive output consistent with a requested inferencing process of relevance to the business unit without modification, by computing system 102, of any of the static, module-specific scripts. Certain of these exemplary, modular and configurable processes may be implemented in addition to, or as an alternative to, the batch-based processes that execute process-specific data pipelining operations based on static, hard-coded scripts or executable application modules and the provision process-specific elements of predictive output not in real-time, but in accordance with the underlying, predetermined and process-specific delivery schedules, at the expected delivery time on the daily, weekly, bi-monthly, or monthly basis described herein.

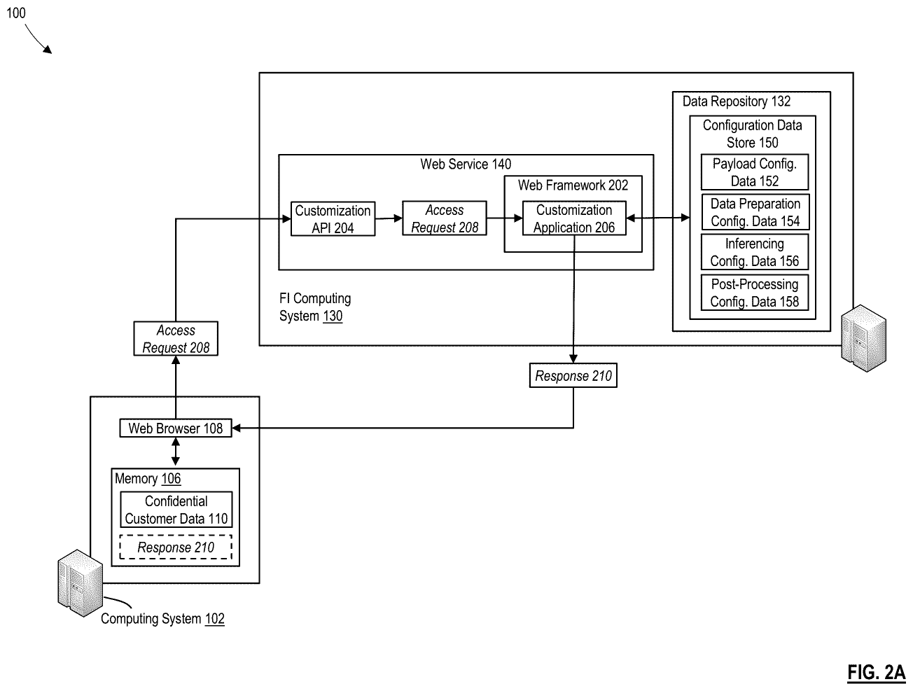

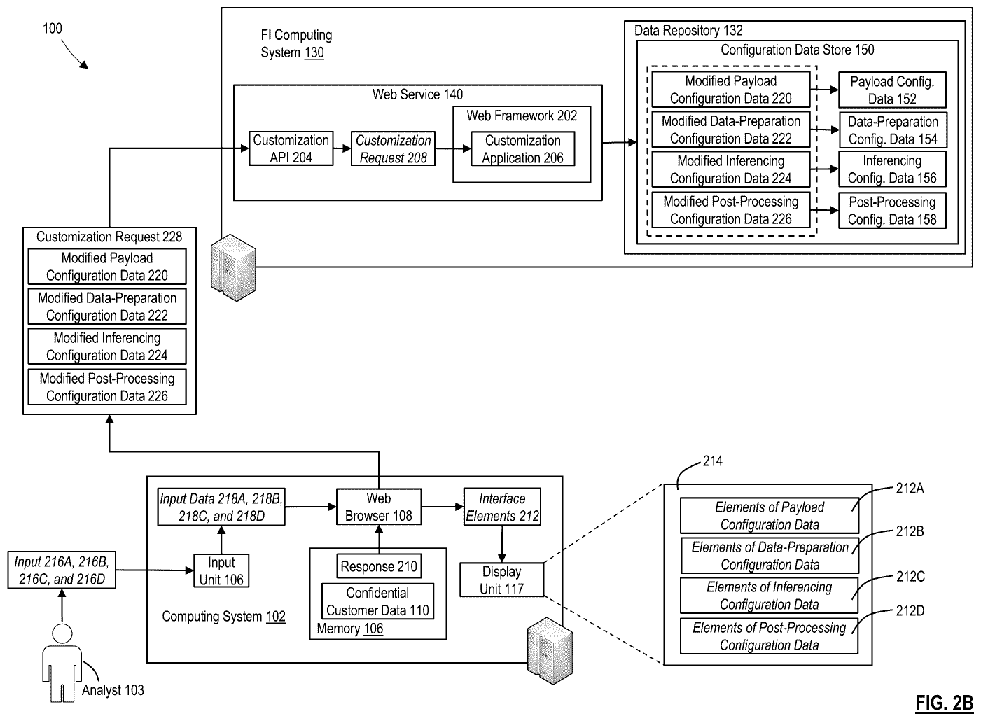

Referring to FIG. 2A, computing system 102 may perform operations that establish a secure, programmatic channel of communications across communications network 120 with one or more of the distributed computing components of FI computing system 130. For example, computing system 102 may execute web browser 108, which cause computing system 102 to exchange data with a web server executed by the one or more processors of FI computing system 130, such executed programmatic web server 140, and to establish the secure, programmatic channel of communications with executed programmatic web server 140 in accordance with one, or more, appropriate communications protocols, such as, but not limited to, a hypertext transfer protocol (HTTP), a transmission control protocol (TCP), or an internet protocol (IP). As described herein, executed programmatic web server 140 may perform operations that establish a corresponding web framework 202, which may orchestrate an execution of one or more application programs, such as, but not limited to, validation application 136 and real-time inferencing application 138, and may establish and maintain programmatic interface associated with each of validation application 136 and real-time inferencing application 138, such as, but not limited to, the validation and real-time inferencing APIs.

Executed programmatic web server 140 may also perform operations that, via established web framework 202, orchestrate an execution of a customization application 206 by the one or more processors of FI computing system 130, and that establish and maintain a programmatic interface associated with executed customization application 206, such as, but not limited to, a customization application programming interface (API) 204. In some instances, and responsive to a corresponding request received from computing system 102 (or from other computing systems associated with corresponding business units of the financial institution), customization API 204 and executed customization application 206 may perform operations, described herein, that enable computing system 102, via executed web browser 108, to access to one or more elements of payload configuration data 152, data-preparation configuration data 154, inferencing configuration data 156, and post-processing configuration data 158 maintain in configuration data store 150, and to update, modify, or “customize” the accessed elements of payload configuration data 152, data-preparation configuration data 154, inferencing configuration data 156, and post-processing configuration data 158 to reflect one or more pre-processing, feature-engineering, inferencing, or post-processing preferences associated inferencing processes requested in real-time by the business unit. As described herein, the modification of the accessed elements of payload configuration data 152, data-preparation configuration data 154, inferencing configuration data 156, and post-processing configuration data 158 by computing system 102 may enable computing system 102 to customize the sequential, pipelined execution of the pipelined application modules without modification to any of the static, module-specific scripts executed by the one or more distributed computing components of FI computing system 130.

Referring back to FIG. 2A, executed web browser 108 may perform operations that generate one or more elements of an access request 208 to access each, or a selected subset, of the elements of payload configuration data 152, data-preparation configuration data 154, inferencing configuration data 156, and post-processing configuration data 158 maintain by FI computing system 130 within configuration data store 150. For example, access request 208 may include, among other things, one or more identifiers of computing system 102 or executed web browser 108, such as, but not limited to, an IP address of computing system 102, a media access control (MAC) address assigned to computing system 102, or a digital token or application cryptogram identifying executed web browser 108 (e.g., a digital token or application cryptogram generated or received while establishing the secure, programmatic channel of communications with executed programmatic web server 140). Access request 208 may also include data identifying each, or the selected subset, of the elements of payload configuration data 152, data-preparation configuration data 154, inferencing configuration data 156, and post-processing configuration data 158, e.g., unique, alphanumeric identifiers of those elements of module-specified configuration data subject to the requested access. Executed web browser 108 may perform operations that cause computing system 102 to transmit access request 208 across communications network 120 to FI computing system, 130, e.g., via the established, secure, programmatic channel of communications using one or more appropriate communications protocols.

In some instances, not illustrated in FIG. 2A, a network firewall associated with, and established by, FI computing system 130 may intercept access request 208 and may perform operations that determine access request 208 complies with one or more network-security policies established by the financial institution and implemented across the distributed computing components of FI computing system 130. If, for example, the network firewall was to determine that access request 208 fails to comply with the one or more network-security policies (e.g., the network firewall intercepted greater than a threshold number of requests from computing system 102 during a corresponding temporal interval, etc.), the network firewall may discard access request 208 and transmit a corresponding error message to computing system 102. Alternatively, if the network firewall were to determine that access request 208 complies with the network-security policies, customization API 204 of executed customization application 206 may receive access request 208, and perform operations that determine whether FI computing system 130 permits a source of access request 208, e.g., computing system 102 or executed web browser 108, to access the elements of module-specific configuration data maintained within configuration data store 150.

For example, customization API 204 may obtain, from access request 208, the one or more identifiers of computing system 102 or executed web browser 108, such as, but not limited to, the IP or MAC address of computing system 102 or the digital token or application cryptogram identifying executed web browser 108, Customization API 204 may also perform operations that determine, based on the one or more identifiers of computing system 102 or executed web browser 108, whether FI computing system 130 grants computing system 102 or executed web browser 108 permission to access the elements of module-specific configuration data maintained within configuration data store 150 (e.g., based on a comparison of the one or more identifiers against a compiled list of blocked computing devices, computing systems, or application programs). If customization API 204 were to establish that FI computing system 130 fails to grant computing system 102, or executed web browser 108, permission to access the elements of module-specific configuration data maintained within configuration data store 150, customization API 204 may discard access request 208 and FI computing system 130 may transmit a corresponding error message to computing system 102.

Alternatively, if customization API 204 were to establish that FI computing system 130 grants computing system 102 and/or executed web browser 108, permission to access the elements of module-specific configuration data maintained within configuration data store 150, customization API 204 may route access request 208 to executed customization application 206. In some instances, executed customization application 206 may obtain, from access request 208, the data identifying each, or the selected subset, of the elements of payload configuration data 152, data-preparation configuration data 154, inferencing configuration data 156, and post-processing configuration data 158 subject to the requested access (e.g., the unique alphanumeric identifiers described herein).

Based on the obtained data, executed customization application 206 may access configuration data store 150 maintained within data repository 132, obtain one or more of the elements of payload configuration data 152, data-preparation configuration data 154, inferencing configuration data 156, and post-processing configuration data 158 that are subject to the requested access, and package the obtained elements into corresponding portions of a response 210 to access request 208. Further, in addition to, or as an alternate to, packaging the requested elements on payload configuration data 152, data-preparation configuration data 154, inferencing configuration data 156, and post-processing configuration data 158 into corresponding portions of response 210, executed customization application 206 may package, into corresponding portions of response 210, hyperlinks or other elements of data identifying, or pointing to, a location of each of the requested elements of payload configuration data 152, data-preparation configuration data 154, inferencing configuration data 156, and post-processing configuration data 158 within data repository 132. In some instances, the hyperlinks or other elements of data may, when processed by executed web browser 108, enable executed web browser to programmatically access each of the of the requested elements of payload configuration data 152, data-preparation configuration data 154, inferencing configuration data 156, and post-processing configuration data 158 within the accessible location, e.g., within configuration data store 150.

Executed customization application 206 may perform operations that cause FI computing system 130 to transmit response 210, including the requested elements on payload configuration data 152, data-preparation configuration data 154, inferencing configuration data 156, and post-processing configuration data 158, and additionally, or alternatively, the hyperlinks or elements of pointer data associated with these requested elements, across communications network 120 to computing system 102. In some instances, executed web browser 108 may receive response 210 and store response 210 within a corresponding portion of a tangible, non-transitory memory, such as within a portion of memory 104.

Referring to FIG. 2B, executed web browser 108 may access response 210 within memory 104, and may obtain the one or more requested elements of payload configuration data 152, data-preparation configuration data 154, inferencing configuration data 156, and post-processing configuration data 158 from response 210. As described herein, the requested elements of payload configuration data 152, data-preparation configuration data 154, inferencing configuration data 156, and post-processing configuration data 158 may be structured and formatted in a Python™-compatible, human-readable data-serialization language, such as, but not limited to, a YAML™ data-serialization language, and executed web browser 108 may perform operations that process the requested elements of payload configuration data 152, data-preparation configuration data 154, inferencing configuration data 156, and post-processing configuration data 158 and generate corresponding interface elements 212, which executed web browser 108 may route to display unit 114 of computing system 102.

In other instances, not illustrated in FIG. 2B, executed web browser 108 may obtain, from response 210, the hyperlinks or other elements of data that identify, or point to, the location of each of the requested elements of payload configuration data 152, data-preparation configuration data 154, inferencing configuration data 156, and post-processing configuration data 158 within data repository 132. Executed web browser 108 may perform operations that, based on the hyperlinks or other elements of data, request and receive the elements of payload configuration data 152, data-preparation configuration data 154, inferencing configuration data 156, and post-processing configuration data 158 from FI computing system 130 across communications network 120, and that generate corresponding ones of interface elements 212 based on requested, and received, elements of payload configuration data 152, data-preparation configuration data 154, inferencing configuration data 156, and post-processing configuration data 158.

Display unit 114 may, for example, receive interface elements 212, which provide a graphical representation of the requested elements of payload configuration data 152, data-preparation configuration data 154, inferencing configuration data 156, and post-processing configuration data 158, and may renders all, or a selected portion, of interface elements 212 for presentation within one or more display screens of digital interface 214. As illustrated in FIG. 2B, digital interface 214 may include, interface elements 212A, which provide a graphical, and editable, representation of the requested elements of payload configuration data 152, interface elements 212B, which provide a graphical, and editable, representation of the requested elements of data-preparation configuration data 154, interface elements 212C, which provide a graphical, and editable, representation of the requested elements of inferencing configuration data 156, and interface elements 212D, which provide a graphical, and editable, representation of the requested elements of post-processing configuration data 158. In some instances, and based on input perceived from analyst 103 via input unit 116, computing system 102 may perform operations that update, modify, or customize corresponding portions of the elements of payload configuration data 152, data-preparation configuration data 154, inferencing configuration data 156, and post-processing configuration data 158 to reflect, among other things, one or more pre-processing, feature-engineering, inferencing, or post-processing processes of relevance to the business unit associated with computing system 102.

By way of example, the business unit associated with computing system 102 may provision an unsecured lending product, such as a credit-card account, to existing or prospective customers of the financial institution, and the business unit may elect, via computing system 102, to pre-approve, or decline, applications for the credit-card account received from devices operable by the existing or prospective customers based on elements of predictive output generated, in real-time, through the sequential execution of the exemplary, data pre-processing, feature-engineering, inferencing, and data post-processing operations described herein. In some instances, the elements of predictive output may indicate a likelihood that a corresponding customer will be associated with a default event involving the credit-card account during a predetermined, future target interval (e.g., twelve months, etc.) based on elements of customer-profile, account, transaction, and credit-bureau data characterizing the corresponding customer during a predetermined, prior extraction interval (e.g., three months, etc.).

Further, the business unit may elect, during the inferencing operations, to apply a trained, gradient-boosted, decision-tree process to a customer-specific input dataset, which may be generated based on an application of one, or more, business-unit-specific feature-engineering operations to the elements of customer-profile, account, transaction, and credit-bureau data (e.g., maintained as nested tables within confidential customer data 112 of memory 104). Additionally, to facilitate the pre-approval, or the decline, of each of the applications for the credit-card account, the business unit may elect to receive the elements of predictive output having numerical values scaled between zero (e.g., indicating a minimal likelihood of an occurrence of the default event) and unity (e.g., indicating a maximum likelihood of an occurrence of the default event), along with explainability data formatted in a specified format, e.g., in DOCX format.

In some instances, to facilitate the modification and customization of the elements of payload configuration data 152, data-preparation configuration data 154, inferencing configuration data 156, and post-processing configuration data 158 to reflect, among other things, one or more pre-processing, feature-engineering, inferencing, or post-processing preferences of the business unit, as described herein, analyst 103 may review interface elements 212A of digital interface 214, which provide the graphical, and editable, representation of the requested elements of payload configuration data 152. In some instances, analyst 103 may provide, to input unit 116, elements of analyst input 216A that, among other things, specify the structure of nested data tables 304 within maintained within confidential customer data 112 of memory 104, including a hierarchical relationship between groups of nested data tables 304 and additionally, or alternatively, one or more primary key indices across nested data tables 304, such as, but not limited to, an alphanumeric customer identifier. Analyst 103 may, in some instances, not elect to modify any of the data pre-processing operations identified within the elements of payload configuration data 152, or the sequence of execution of these data pre-processing operations.

Input unit 116 may, for example, may receive analyst input 216A, and may route corresponding elements of input data 218A to executed web browser 108. As illustrated in FIG. 2B, executed web browser 108 may perform operations that parse input data 218A, and that modify the elements of payload configuration data 152 to reflect the analyst-specified structure of the nested data tables, the analyst-specified hierarchical relationship between the groups of the nested data tables, and the analyst-specified primary key indices, and generate corresponding elements of modified payload configuration data 220.

Further, analyst 103 may also review interface elements 212B of digital interface 214, which provide the graphical, and editable, representation of the requested elements of data-preparation configuration data 154, and may provide, to input unit 116, additional elements of analyst input 216B that, among other things, includes data identifying the plurality of features of the input dataset and a sequential position of each of the features within the input dataset, data identifying each of the business-unit-specific feature-engineering operations, parameter values that characterize each of the business-unit-specific, feature-engineering operations, and additionally, or alternatively, data characterizing an order of sequential, or parallel, application of the business-unit-specific feature-engineering operations. By way of example, and as described herein, the feature-engineering operations specified by the business unit for a corresponding one of the feature may include one or more aggregation operations associated with corresponding elements of customer account data (e.g., balances of unsecured credit products, etc.) during the extraction interval (e.g., three months), and analyst input 216B may specify a corresponding operation identifier for the aggregation operation (e.g., an average, a maximum, etc.), the extraction interval (e.g., three months, etc.), and an identifier of the feature and the corresponding element of customer account data (e.g., account balance of unsecured credit products, etc.), and data characterizing an order of sequential or parallel application of the one or more aggregation operations.

Additionally, in some instances, analyst input 216B may also include data characterizing a structure or format of the input dataset of generated, computed, or derived feature values, such as, but not limited to, the Python™-compatible pandas dataframe described herein. Input unit 116 may, for example, may receive analyst input 216B, and may route corresponding elements of input data 218B to executed web browser 108, which may perform operations that parse input data 218B, and that modify the elements of data-preparation configuration data 154 to reflect analyst-specified input data 218B and that generate corresponding elements of modified data-preparation configuration data 222.

Analyst 103 may also review interface elements 212C of digital interface 214, which provide the graphical, and editable, representation of the requested elements of inferencing configuration data 156, and may provide, to input unit 116, additional elements of analyst input 216C that, among other things, specify an unique identifier of the trained, gradient-boosted, decision-tree process associated with the requested inferencing operations (e.g., an alphanumeric identifier of the trained XGBoost process, etc.), and include data identifying the target (e.g., the predicted likelihood that a customer will be associated with a default event involving the credit-card account during the predetermined, future target interval) and the predetermined, future target interval (e.g., twelve months, etc.), data characterizing a format of the elements of predictive output (floating-point values indicative of the likelihood of the occurrence of the target event during the predetermined, future target interval), and further, data specifying a format of the explainability data generated in conjunction with the requested inferencing operation (e.g., explainability data in DOCX format). Input unit 116 may, for example, may receive analyst input 216C, and may route corresponding elements of input data 218C to executed web browser 108, which may perform operations that parse input data 218C, and that modify the elements of inferencing configuration data 156 to reflect analyst-specified input data 218C and that generate corresponding elements of modified inferencing configuration data 224.

Additionally, analyst 103 may review interface elements 212D, which provide the graphical, and editable, representation of the requested elements of post-processing configuration data 158. In some instances, analyst 103 may provide, to input unit 116, additional elements of analyst input 216D that include, among other things, data that characterizes the scaling operation applied to the elements of predictive output, as specified by the business unit (e.g., scaling the floating-point values of the elements of predictive output from zero to unity, as described herein). Input unit 116 may, for example, may receive analyst input 216D, and may route corresponding elements of input data 218D to executed web browser 108, which may perform operations that parse input data 218D, and that modify the elements of post-processing configuration data 158 to reflect analyst-specified input data 218D and that generate corresponding elements of modified post-processing configuration data 226.

Executed web browser 108 may perform operations that package the elements of modified payload configuration data 220, the elements of modified data-preparation configuration data 222, the elements of modified inferencing configuration data 224, the elements of modified post-processing configuration data 226 into corresponding portions of a customization request 228. In some instances, executed web browser 108 may also package, into an additional portion of customization request 228, the one or more identifiers of computing system 102 or executed web browser 108, such as, but not limited to, the IP or MAC address of computing system 102, or the digital token or application cryptogram identifying executed web browser 108. Executed web browser 108 may also perform operations that cause computing system 102 to transmit customization request 228 across communications network 120 to FI computing system 130.

In some instances, not illustrated in FIG. 2B, the network firewall associated with, and established by, FI computing system 130 may intercept customization request 228 and may perform operations that determine whether customization request 228 complies with the one or more network-security policies established by the financial institution and implemented across the distributed computing components of FI computing system 130. If, for example, the network firewall was to determine that customization request 228 fails to comply with the one or more network-security policies (e.g., the network firewall intercepted greater than a threshold number of requests from computing system 102 during a corresponding temporal interval, etc.), the network firewall may discard customization request 228 and transmit a corresponding error message to computing system 102. Alternatively, if the network firewall were to determine that customization request 228 complies with the network-security policies, customization API 204 of executed customization application 206 may receive customization request 228, and perform any of the exemplary processes described herein to determine whether FI computing system 130 permits a source of customization request 228, e.g., computing system 102 or executed web browser 108, to modify or customize the elements of module-specific configuration data maintained within configuration data store 150.

If, for example customization API 204 were to establish that FI computing system 130 fails to grant computing system 102, or executed web browser 108, permission to modify or customize the elements of module-specific configuration data maintained within configuration data store 150, customization API 204 may discard customization request 228 and FI computing system 130 may transmit a corresponding error message to computing system 102. Alternatively, if customization API 204 were to establish that FI computing system 130 grants computing system 102 and/or executed web browser 108, permission to modify or customize the elements of module-specific configuration data maintained within configuration data store 150, customization API 204 may route customization request 228 to executed customization application 206.

In some instances, executed customization application 206 may obtain, from access request 208, the elements of modified payload configuration data 220, the elements of modified data-preparation configuration data 222, the elements of modified inferencing configuration data 224, the elements of modified post-processing configuration data 226, which reflect the one or more pre-processing, feature-engineering, inferencing, or post-processing preferences of relevance to the real-time inferencing processes requested by the business unit associated with computing system 102. Executed customization application 206 may access configuration data store 150 maintained within data repository 132, and perform operations that replace, or modify, the elements of payload configuration data 152, data-preparation configuration data 154, inferencing configuration data 156, and post-processing configuration data 158 based on, and on accordance with, corresponding ones of the elements of modified payload configuration data 220, the elements of modified data-preparation configuration data 222, the elements of modified inferencing configuration data 224, and the elements of modified post-processing configuration data 226. Through a modification of one or more of the module-specific elements of configuration data to reflect the one or more pre-processing, feature-engineering, inferencing, or post-processing preferences of the business unit associated with computing system 102, the exemplary processes described herein may enable computing system 102 to customize the sequential, pipelined execution of the application modules and receive, in real-time, transformed elements of predictive output consistent with a requested inferencing process of relevance to the business unit, without modification, by computing system 102, to any of the static, module-specific scripts executed by the one or more distributed computing components of FI computing system 130.

In some instances, an existing or prospective customer of the financial institution, such user 119, may elect to apply for a credit-card account available provisioning by the business the business unit associated with computing system 102, and one or more application programs executed by a computing device or system operable by the existing or prospective customer, such as a mobile banking application executed at client device 118, may generate elements of application data characterizing user 119 and the credit card account, and may transmit the elements of application data across communications network 120 to computing system 102. In some examples, computing system 102 may receive the elements of application data, and may perform operations that route the elements of application data to FI computing system 130, either individually or in batch form in conjunction with elements of application data characterizing hundreds, if not thousands, of additional existing or prospective customers of the financial institution, and FI computing system 130 may perform one or more batch-based processes that execute process-specific data pipelining operations based on static, hard-coded scripts or executable application modules and that provision process-specific elements of predictive output characterizing not only the application of user 119, but also the applications of the hundreds or thousands of the additional existing or prospective customers, in accordance with the underlying, predetermined and process-specific delivery schedules, e.g., at the expected delivery time on the daily, weekly, bi-monthly, or monthly basis described herein. In some instances, computing system 102 may perform operations that approve, or decline, the application for the credit-card account by user 119 based on corresponding elements of the process-specific elements of predictive output characterizing user 119 upon receipt from FI computing system at the scheduled delivery time, which may be days or weeks subsequent to the submission of the elements of application data to computing system 102.

In other instances, described herein, computing system 102 may receive the elements of application data, which characterize user 119 and the application for the credit-card account, and generate corresponding elements of a real-time inferencing request that, upon transmission to and receipt at FI computing system 130, cause the distributed computing components of FI computing system 130 to perform one or more of the exemplary processes described herein to execute sequentially a plurality of pipelined applications modules in accordance with customized elements of module-specific configuration data that reflect one or more preferences of the business unit. As described, the sequential execution of the plurality of pipelined applications modules in accordance with that customized elements of module-specific configuration data may enable the distributed computing components of FI computing system 130 to generate and provision, in real-time to computing system 102, transformed elements of predictive output consistent with a requested inferencing process of relevance to the business unit, and the application of user 119 for the credit-card account, without modification, by computing system 102, to any of the static, module-specific scripts executed by the one or more distributed computing components of FI computing system 130. Through a performance of these exemplary processes, computing system 102 may perform operations that generate a decision on a pre-approval of the application by user 119 for the credit-card account based on the transformed elements of predictive output, and provision that pre-approval decision to client device 118 (and to user 119) in real-time and contemporaneously with a receipt of the elements of application data at computing system 102, e.g., within a predetermined time period subsequent to the receipt of the elements of application data, such as, but not limited to, thirty seconds, one minute, ninety seconds, two minutes, or three minutes.

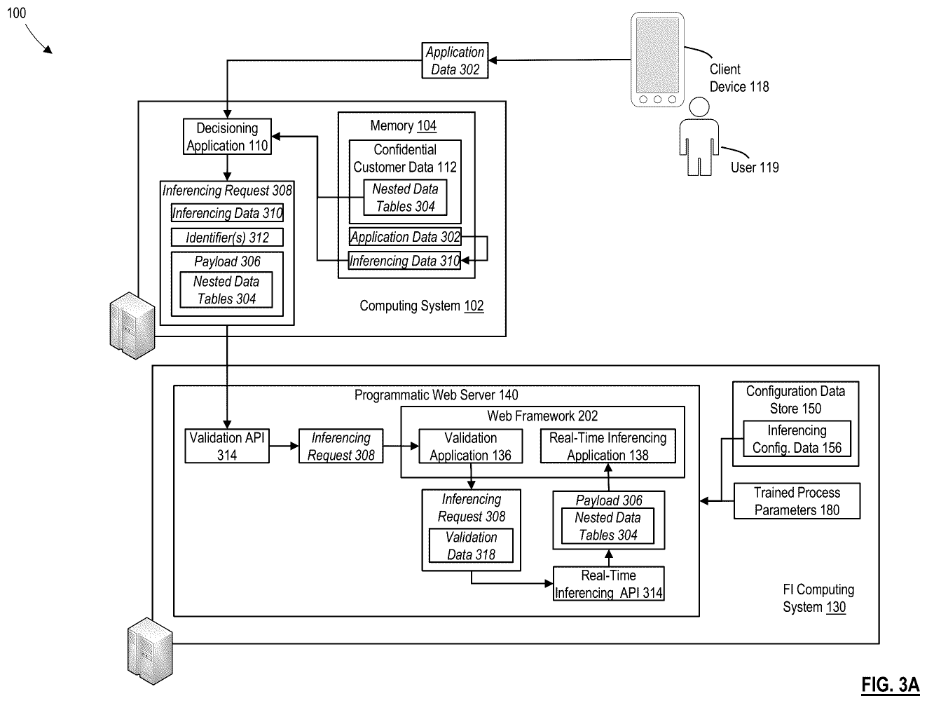

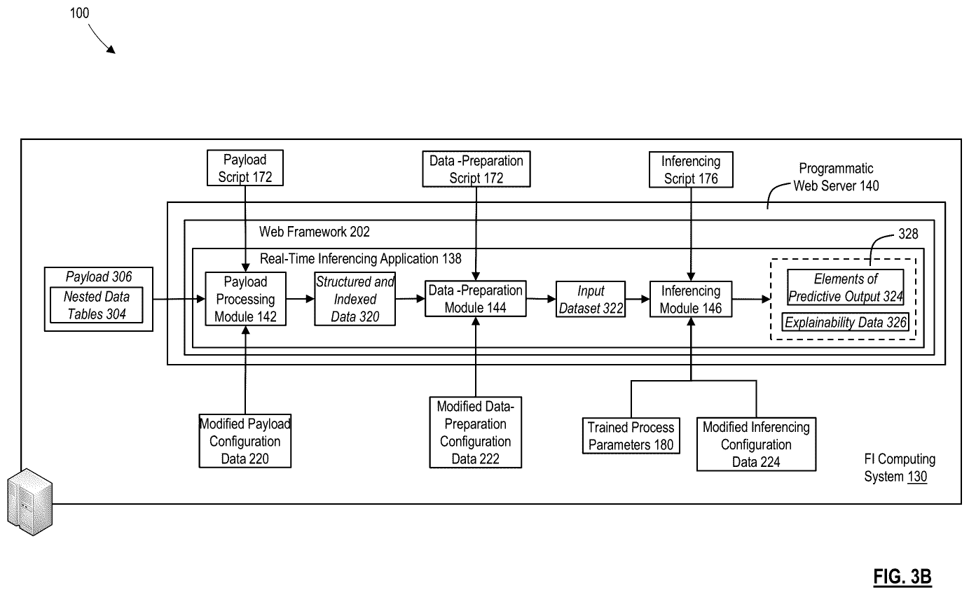

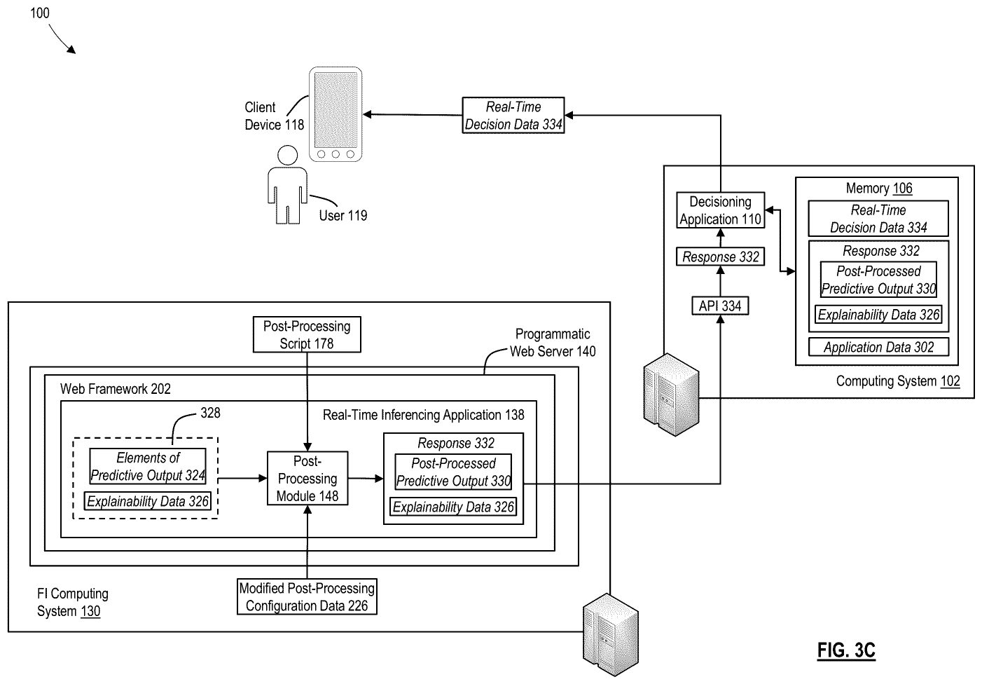

Referring to FIG. 3A, client device 118 may generate the one or more elements of application data, such as application data 302, that identify and characterize user 119 and the application of user 119 for the credit-card account, and may transmit application data 302 across communications network 120 to computing system 102. In some instances, application data 302 may include one or more identifiers of user 119, such as an alphanumeric identifier assigned to user 119 by the financial institution (e.g., a login credential, etc.) or by a governmental entity (e.g., a social-security number or a driver's license number, etc.), and one or more identifiers of the credit-card account (e.g., an alphanumeric product identifier assigned by the financial institution, etc.), and computing system 102 may store application data 302 within a corresponding portion of a tangible, non-transitory memory, e.g., within a portion of memory 104.

Further, in some instances, one or more application programs executed by processor(s) 106 of computing system 102, such executed decisioning application 110, may detect a receipt of application data 302, and may perform any of the exemplary operations described herein to establish a secure, programmatic channel of communications across communications network 120 with a web server executed by the one or more processors of FI computing system 130, such executed programmatic web server 140, in accordance with one, or more, appropriate communications protocols, such as, but not limited to, a hypertext transfer protocol (HTTP), a transmission control protocol (TCP), or an internet protocol (IP). As described herein, executed programmatic web server 140 may perform operations that establish web framework 202, which may orchestrate an execution of one or more application programs, such as, but not limited to, validation application 136 and real-time inferencing application 138, and may establish and maintain programmatic interfaces associated with each of validation application 136 and real-time inferencing application 138, such as, but not limited to, a validation application programming interface (API) 314 and a real-time inferencing API 316.

In some instances, executed decisioning application 110 may perform operations that access the elements of application data 302 maintained within memory 104, and obtain the one or more identifiers of user 119 from the accessed elements of application data 302. Based on the one or more identifiers of user 119, executed decisioning application 110 may determine that one, or multiple, nested data tables 304 maintained within confidential customer data 112 include, or reference, the one or more identifiers of user 119 (and as such, include elements of customer-profile, account, transaction, and/or credit bureau data that characterize user 119 across multiple temporal intervals). Each of nested data tables 304 may be formatted or structured in a standardized data-exchange format, such as JSON™ or an extensible markup language (XML), and executed decisioning application 110 may perform operations that package nested data tables 304 within a payload 306 of a real-time inferencing request 308.

Further, and based on the accessed elements of application data 302, executed decisioning application 110 may associate the application of user 119 for the credit-card account with one or more real-time inferencing operations that facilitate a decision, by computing system 102, to pre-approve or alternatively, decline, the application of user 119 for the credit-card account based on corresponding, and customer-specific, elements of predictive output generated through the application of a trained, gradient-boosted, decision-tree process to elements of input data associated with user 119 and characterizing a likelihood that user 119 will be associated with a default event involving the credit-card account during a predetermined, future target interval (e.g., twelve months, etc.). In some instances, executed decisioning application 110 may obtain, from memory 104, one or more elements of inferencing data 310, which characterize only the real-time inferencing process associated with the decision to pre-approve or alternatively, decline, the application of user 119 for the credit-card account (e.g., (e.g., an identifier of a trained, gradient-boosted, decision-tree process, such as a trained XGBoost process), but also one or more preferences of the business unit for the real-time inferencing operations.

The one or more preferences may, for example, define the target of the inferencing process (e.g., the predicted likelihood that user 119 will be involved in an occurrence of a default event involving the credit-card account during a predetermined, future target interval) and the target future interval (e.g., the future, twelve-month interval, etc.), and in some instances, the computing system 102 may generate the elements of inferencing data 310 during implementation of those processes, described herein, that update, modify, or customize the elements of module-specific configuration data. In some instances, executed decisioning application 110 may package the elements of inferencing data 310 into a corresponding portion of real-time inferencing request 308.

Further, executed decisioning application 110 may also perform operations that obtain, or generate, one or more identifiers 312 of computing system 102 or executed decisioning application 110, such as, but not limited to, the IP address of computing system 102, the MAC address assigned to computing system 102, or a digital token or application cryptogram identifying executed decisioning application 110 (e.g., a digital token or application cryptogram generated or received while establishing the secure, programmatic channel of communications with executed programmatic web server 140). Executed decisioning application 110 may package identifier 312 into a corresponding portion of real-time inferencing request 308, and executed decisioning application 110 may perform operations that cause computing system 102 to transmit real-time inferencing request across communications network 120 to FI computing system 130.

In some instances, not illustrated in FIG. 3A, the network firewall associated with, and established by, FI computing system 130 may intercept real-time inferencing request 308 and may perform operations that determine whether real-time inferencing request 308 complies with the one or more network-security policies established by the financial institution and implemented across the distributed computing components of FI computing system 130. If, for example, the network firewall was to determine that real-time inferencing request 308 fails to comply with the one or more network-security policies (e.g., the network firewall intercepted greater than a threshold number of requests from computing system 102 during a corresponding temporal interval, etc.), the network firewall may discard real-time inferencing request 308 and transmit a corresponding error message to computing system 102. Alternatively, if the network firewall were to determine that real-time inferencing request 308 complies with the network-security policies, validation API 314 associated with executed validation application 136 may receive real-time inferencing request 308, and determine whether a structure, format, or composition of the real-time inferencing request 308 is consistent with an expected structure, format, or composition of requests from computing systems associated with the business units of the financial institution.

If, for example, validation API 314 were to detect an inconsistency between the structure, format, or composition of real-time inferencing request 308 and the expected structure, format, or composition, validation API 314 may discard real-time inferencing request 308 and in some instances, may perform operations that transmit an error message across communications network 120 to the source, e.g., to computing system 102. Alternatively, if validation API 314 were to determine a consistency between the structure, format, or composition of the real-time inferencing request 308 and the expected structure, format, or composition, validation API 314 may perform operations that route the real-time inferencing request 308 to executed validation application 136, which may perform operations that determine whether a source of the real-time inferencing request 308 (e.g., computing system 102) is permitted to request real-time inferencing, and additionally, or alternatively, to determine whether the real-time inferencing processes requested by the business unit are within the scope of the trained machine-learning or artificial intelligence processes available at FI computing system 130.

For example, executed validation application 136 may obtain, from real-time inferencing request 308, one or more elements of inferencing data 310 associated with real-time inferencing operations requested by the business unit associated with computing system 102, and one or more identifiers 312 of computing system 102 or executed web browser 108, such as, but not limited to, the IP or MAC address of computing system 102 or the digital token or application cryptogram identifying executed decisioning application 110. As described herein, one or more elements of inferencing data 310 may identify and characterize the real-time inferences operations associated with the decision to pre-approve or alternatively, decline, the application of user 119 for the credit-card account (e.g., an identifier of a trained, gradient-boosted, decision-tree process, such as a trained XGBoost process), but also one or more preferences of the business unit for the real-time inferencing operations, such as, but not limited to, the target of the inferencing process (e.g., the predicted likelihood that user 119 will be associated with a default event involving the credit-card account during a predetermined, future target interval) and the target future interval (e.g., the future, twelve-month interval, etc.).

In some instances, and based on identifiers 312 of computing system 102 or executed web browser 108, executed validation application 136 may perform operations that determine whether FI computing system 130 grants computing system 102 or executed decisioning application 110 permission to request real-time inferencing (e.g., based on a comparison of the one or more identifiers against a compiled list of blocked computing devices, computing systems, or application programs). Further, executed validation application 136 may also perform operations, based on the elements of inferencing data 310, that determine whether the real-time inferencing processes requested by the business unit are within the scope of the trained machine-learning or artificial intelligence processes available at FI computing system 130. For example, executed validation application 136 may access one or more elements of modified inferencing configuration data 224 (e.g., as maintained within configuration data store 150) and elements of trained process parameters 160 maintained within data repository 132, and determine whether the elements of modified inferencing configuration data 224 include the identifier of a trained, gradient-boosted, decision-tree process, such as a trained XGBoost process (e.g., that the elements of inferencing data 310 and modified inferencing configuration data 224 reference a common trained, machine-learning or artificial-intelligence process), and that the elements of trained process parameters 160 not only include parameter values associated with the identifier of the trained, gradient-boosted, decision-tree process (e.g., the trained XGBoost process), but parameter values sufficient to establish and execute the trained, gradient-boosted, decision-tree process.

If, for example, executed validation application 136 were to establish that FI computing system 130 fails to grant computing system 102, or executed decisioning application 110, permission to request real-time inferencing, or that the real-time inferencing operations requested by the business unit fall outside the scope of the trained machine-learning or artificial intelligence processes available at FI computing system 130 (e.g., the elements of inferencing data 310 and modified inferencing configuration data 224 reference different trained, machine-learning or artificial-intelligence processes, the elements of trained process parameters 160 fail to associate process parameter values with the identifier of the trained, gradient-boosted, decision-tree process, and/or the process parameter values are insufficient to establish and execute the trained, gradient-boosted, decision-tree process), executed validation application 136 may discard real-time inferencing request 308 and FI computing system 130 may transmit a corresponding error message to computing system 102.

Alternatively, if executed validation application 136 were to establish that FI computing system 130 grants computing system 102, or executed decisioning application 110, permission to request real-time inferencing, and that the real-time inferencing operations requested by the business unit are within the scope of the trained machine-learning or artificial intelligence processes available at FI computing system 130 (e.g., the elements of inferencing data 310 and modified inferencing configuration data 224 reference a common trained, machine-learning or artificial-intelligence processes, the elements of trained process parameters 160 include process parameter values associated with the trained, gradient-boosted, decision-tree process, and the process parameter values are sufficient to establish and execute the trained, gradient-boosted, decision-tree process), executed validation application 136 may validate real-time inferencing request 308, and may perform operation that generate an append an element of validation data 318, which confirms the successful validation of real-time inferencing request 308, to a portion of real-time inferencing request 308.

In some instances, executed validation application 136 may route now-validated real-time inferencing request 308, which includes inferencing data 310, identifiers 312, payload 306, and the appended element of validation data 318, to real-time inferencing API 316 associated with real-time inferencing application 138, which may be established and maintained by executed programmatic web server 140. Real-time inferencing API 316 may, for example, receive real-time inferencing request 308, including inferencing data 310, identifiers 312, payload 306, and the appended element of validation data 318, and may perform operations that determine whether a structure, format, or composition of the real-time inferencing request 308 is consistent with an expected structure, format, or composition of validated requests from computing systems associated with the business units of the financial institution, and further, whether real-time inferencing request 308 includes an appended element of validation data (of predetermined structure or composition recognizable by real-time inferencing API 316) indicative of a successful validation of real-time inferencing request 308 by executed validation application 136.

If, for example, real-time inferencing API 316 were to detect an inconsistency between the structure, format, or composition of real-time inferencing request 308 and the expected structure, format, or composition, or alternatively, and absence of the appended element of validation data or an inconsistency between a structure of composition of the appended element of validation data and the predetermined structure or composition, real-time inferencing API 316 may discard real-time inferencing request 308 and in some instances, may transmit an error message across communications network 120 to computing system 102. Alternatively, if real-time inferencing API 316 were to determine a consistency between the structure, format, or composition of the real-time inferencing request 308 and the expected structure, format, or composition, and to confirm both a presence of the appended element of validation data and a consistency between the structure of composition of the appended element of validation data and the predetermined structure or composition, real-time inferencing API 316 may perform operations that extract payload 306 (including nested data tables 304) from real-time inferencing request 308 and route payload 306 (including nested data tables 304) to web framework 202 of executed programmatic web server 140.

In some instances, a receipt of payload 306 (including nested data tables 304) by web framework 202 of executed programmatic web server 140, may trigger a programmatic execution of real-time inferencing application 138 by the one or more processors of FI computing system 130, and may cause web framework 202 to access script data store 170, and obtain payload script 172, data-preparation script 174, inferencing script 176, and post-processing script 178. As described herein, each of executed payload processing module 142, data-preparation module 144, inferencing module 146, and post-processing module 148 may performs consistent with a corresponding one of payload script 172, data-preparation script 174, inferencing script 176, and post-processing script 178, and in accordance with corresponding ones of the module-specific elements of configuration data customized to reflect the one or more pre-processing, feature-engineering, inferencing, or post-processing preferences of the business unit associated with computing system 102 (e.g., respective elements of modified payload configuration data 220, modified data-preparation configuration data 222, modified inferencing configuration data 224, and modified post-processing configuration data 226).

Referring to FIG. 3B, payload processing module 142 of executed real-time inferencing application 138 may receive, from real-time inferencing API 316, payload 306 (including nested data tables 304) extracted from real-time inferencing request 308. As described herein, nested data tables 304 may include one, or multiple, nested data tables that maintain elements of customer-profile, account, transaction, and/or credit bureau data that identify and characterize user 119, and interactions between user 119 and the financial institution, unrelated financial institutions, and other unrelated entities within the financial services industry, across multiple temporal intervals, and each of nested data tables 304 may be formatted or structured in a standardized data-exchange format, such as JSON™ or an extensible markup language (XML). In some instances, executed payload processing module 142 may also perform operations that obtain, from configuration data store 150, one or more elements of modified payload configuration data 220, which may be customized to reflect the data one or more pre-processing preferences of the business unit associated with computing system 102 using any of the exemplary processes described herein. The elements of modified payload configuration data 220 may specify the structure of nested data tables 304 within maintained within confidential customer data 112 of memory 104, including a hierarchical relationship between groups of nested data tables 304 and additionally, or alternatively, one or more primary key indices across nested data tables 304, such as, but not limited to, an alphanumeric customer identifier.

Further, in some instances, the elements of modified payload configuration data 220 may identify, and specify values of parameters characterizing, one or more data pre-processing operations applied to nested data tables 304 by executed payload processing module 142. Examples of these data pre-processing operations include, but are not limited to, operations that receive payload 306 and extract nested data tables 304 from payload 306, operations that confirm that each of nested data tables 304 include the primary key index or indices, operations that process and “flatten” nested data tables 304, that generate elements of indexing data (e.g., a Python™ structured dictionary or other associative array, etc.) indexing the flattened tabular data in accordance with the corresponding primary key index or indices, and that generate elements of structured and indexed output data that include the flattened tabular data and in some instances, the indexing data. Executed payload processing module 142 may perform operations that obtain payload script 172 from script data store 170, and once processed and executed, payload script 172 may cause executed payload processing module 142 to execute each of the data-pre-processing operations in accordance with the sequence and the parameter values specified within modified payload configuration data 220.

For example, referring back to FIG. 3B, executed payload processing module 142 may perform operations, consistent with the elements of modified payload configuration data 220, the receive payload 306 from real-time inferencing API 316, that extract nested data tables 304 from payload 306, that confirm that each of nested data tables 304 include the primary key index or indices, such as, but not limited to, the alphanumeric customer identifier described herein. In some instances, if executed payload processing module 142 were to determine that at least one of nested data tables 304 fails to include the primary key index or indices, executed payload processing module 142 may perform additional data pre-processing operations that augment the at least one of nested data tables 304 to include the primary key index or indices. Further, and consistent with the elements of modified payload configuration data 220, executed payload processing module 142 may perform operations that process and “flatten” nested data tables 304 and generate corresponding elements of flattened tabular data, and that generate elements of indexing data (e.g., a Python™ structured dictionary or other associative array, etc.) that index the corresponding now-flatted tabular data in accordance with corresponding primary key index or indices. Executed payload processing module 142 may perform operations, consistent with the elements of modified payload configuration data 220, that generate elements of structured and indexed data 320 that include the elements of flattened tabular data and in some instances, the generated indexing data.

In some instances, data-preparation module 144 of executed real-time inferencing application 138 may receive the elements of structured and indexed data 320 from executed payload processing module 142. Executed payload processing module 142 may also perform operations that obtain, from configuration data store 150, one or more elements of modified data-preparation configuration data 222, which may be customized to reflect the data one or more data-preparation and feature-engineering preferences of the business unit associated with computing system 102 using any of the exemplary processes described herein. By way of example, and as described herein, the elements of modified data-preparation configuration data 222 may include data identifying the plurality of features of an input dataset that reflect the data-preparation and feature-engineering preferences of the business unit and a sequential position of each of the features within the input dataset.

Further, in some instances, elements of modified data-preparation configuration data 222 may also include data identifying one or more feature-engineering operations (e.g., reflecting the data-preparation and feature-engineering preferences of the business unit) that, when applied to the elements of structured and indexed data 320 by executed data-preparation module 144, generate, compute, or derive corresponding ones of the of the feature values, parameter values that characterize each of the feature-engineering operations, and data characterizing an order of sequential, or parallel, application of the feature-engineering operations to the elements of structured and indexed data 320. By way of example, and as described herein, the feature-engineering operations specified by the business unit for a corresponding one of the features may include one or more aggregation operations associated with corresponding elements of customer account data (e.g., balances of unsecured credit products, etc.) associated with the extraction interval (e.g., three months) and maintained within the elements of structured and indexed data 320. As described herein, the elements of modified data-preparation configuration data 222 may include a corresponding operation identifier for the aggregation operation (e.g., an average, a maximum, etc.), the extraction interval (e.g., three months, etc.), and an identifier of the feature and the corresponding element of customer account data (e.g., account balance of unsecured credit products, etc.). Additionally, in some instances, the elements of modified data-preparation configuration data 222 may also include data characterizing a structure or format of the input dataset of generated, computed, or derived feature values, such as, but not limited to, the Python™-compatible pandas dataframe described herein.

Executed data-preparation module 144 may also perform operations that obtain data-preparation script 174, from script data store 170, and once processed and executed, data-preparation script 174 may cause data-preparation module 144 to perform operations that, for each of the features specified within modified data-preparation configuration data 222, apply the feature-engineering operations to the elements of structured and indexed data 320 in accordance with the sequence and parameter values specified within the elements of modified data-preparation configuration data 222. For example, executed data-preparation module 144 may perform operations, consistent with modified data-preparation configuration data 222, that receive the elements of structured and indexed data 320 from executed payload processing module 142, and perform operations that, for each of the features specified within modified data-preparation configuration data 222: (i) apply corresponding of the feature-engineering operations to the elements of structured and indexed data 320 in accordance with the specified sequence and the specified parameter value; (ii) generate a corresponding feature value based on the application of the feature-engineering operations to the elements of structured and indexed data 320; and (iii) store the corresponding feature values at a sequential position within an input dataset 322 specified with the elements of modified data-preparation configuration data 222. In some instances, as described herein, input dataset 322 may be characterized by a structure or a format consistent with the data-preparation preferences of the business unit associated with computing system 102, such as, but not limited to, the Python™-compatible pandas dataframe described herein.

Further, as illustrated in FIG. 3B, inferencing module 146 of executed real-time inferencing application 138 may receive input dataset 322 from executed data-preparation module 144. As described herein, input dataset 322 may include one or more feature values, which may be disposed at sequential positions within input dataset 322, and input dataset 322 may be formatted and structured as a Python™-compatible pandas dataframe. In some instances, executed inferencing module 146 may also perform operations that obtain, from configuration data store 150, elements of modified inferencing configuration data 224, which may be customized to reflect the data one or more inferencing preferences of the business unit associated with computing system 102 using any of the exemplary processes described herein.

By way of example, and as described herein, the elements of modified inferencing configuration data 224 may include an identifier of a trained machine-learning or artificial-intelligence process associated with the requested, real-time inferencing operations and available for application to input dataset 322 (e.g., an alphanumeric identifier of a trained, gradient-boosted, decision-tree process, such as a trained XGBoost process), data that defines a target of the requested, real-time inferencing operations (e.g., the predicted likelihood that user 119 will be associated with a default event involving the credit-card account during a predetermined, future target interval) and the target future interval (e.g., the future, twelve-month interval, etc.). Further, in some examples, the elements of modified inferencing configuration data 224 may also define a format of the elements of predictive output generated by the requested, real-time inferencing process (e.g., floating-point values indicative of the likelihood of the occurrence of the target event during the predetermined, future target interval), and further, a format of the explainability data generated in conjunction with the requested inferencing operation (e.g., explainability data in DOCX format).

In some instances, and based on the identifier of the trained machine-learning or artificial-intelligence process (e.g., the alphanumeric identifier of a trained, gradient-boosted, decision-tree process, such as the trained XGBoost process), executed inferencing module 146 may access and obtain elements of trained process parameters 160, which include value of one or more process parameters associated with the trained machine-learning or artificial-intelligence process consistent with the inferencing preferences of the business unit associated with computing system 102. By way of example, and for the trained, gradient-boosted, decision-tree process (e.g., the trained XGBoost process), the obtained process parameter values may include, but are not limited to, a value of a learning rate associated with the trained, gradient-boosted, decision-tree process, a number of discrete decision trees included within the trained, gradient-boosted, decision-tree process (e.g., the “n_estimator” for the trained, gradient-boosted, decision-tree process), a tree depth characterizing a depth of each of the discrete decision trees included within the trained, gradient-boosted, decision-tree process, a minimum number of observations in terminal nodes of the decision trees, and/or values of one or more hyperparameters that reduce potential process overfitting (e.g., regularization of pseudo-regularization hyperparameters).

Executed inferencing module 146 may perform operations that obtain inferencing script 176 from script data store 170, and once processed and executed, inferencing script 176 may cause executed inferencing module 146 to perform operations that establish the plurality of nodes and the plurality of decision trees for the trained, gradient-boosted, decision-tree process in accordance with the process parameter values specified within the elements of trained process parameter data 180, and that apply the trained, gradient-boosted, decision-tree process to input dataset 322, e.g., based on an ingestion and processing of the feature values maintained within the input dataset by the established nodes and decision trees of the trained, gradient-boosted, decision-tree process. Based on the application of the trained, gradient-boosted, decision-tree process to the input dataset, executed inferencing module 146 may perform additional operations, consistent with inferencing script 176, that generate one or more elements of predictive output 324 that are structured or formatted in accordance with the modified inferencing configuration data 224, e.g., as floating point values.

Further, in some examples, and consistent with inferencing script 176, executed inferencing module 146 may generate one or more elements of explainability data 326 that characterize predictive output 324 or an impact of each, or a selected subset of, the feature values maintained within input dataset 322 on predictive output 324. For example, the elements of explainability data 326 may include one or more Shapley feature values that a relative of importance of each of the discrete features within input dataset 322 on predictive output 324, or alternatively, a subset of the discrete features within the input dataset, such as, but not limited to, a predetermined number of discrete features associated with maximum or minimum Shapley feature values (e.g., as specified within inferencing script 176 or by computing system 102 within modified inferencing configuration data 224). The disclosed embodiments are, however, not limited to elements of explainability data 326 that include Shapley feature values, and in other instances, the elements of explainability data 326 generated by executed inferencing module 146 may also include values of one or more deterministic or probabilistic metrics that characterize the relative importance of discrete features within input dataset 322, such as, but not limited to, computed precision values, computed recall values, computed areas under curve (AUCs) for receiver operating characteristic (ROC) curves or precision-recall (PR) curves, and/or computed multiclass, one-versus-all areas under curve (MAUCs) for ROC curves.

Executed inferencing module 146 may perform further operations, consistent with inferencing script 176, that structure the elements of explainability data 326 in accordance with modified inferencing configuration data 224 (e.g., in a file format specified by computing system 102 using any of the exemplary processes described herein, such as a DOCX format), and that package the elements of predictive output 324 and the elements of explainability data 326 into corresponding elements of inferencing output data 328. In some examples, the elements of modified inferencing configuration data 224 may specify that inferencing output data 328 includes one or more elements of indexing data (e.g., a Python™ structured dictionary or other associative array, etc.) that indexes the corresponding elements of predictive output data and explainability data in accordance with a corresponding primary key index or primary key indices, and executed inferencing module 146 may perform further operations, consistent with inferencing script 176, generating the elements of indexing data that index predictive output 324 and the elements of explainability data 326 in accordance with the primary key index or indices, and that package the elements of indexing data into inferencing output data 328.

Referring to FIG. 3C, post-processing module 148 of executed real-time inferencing application 138 may receive inferencing output data 328, including predictive output 324 and the elements of explainability data 326, from executed inferencing module 146. As described herein, predictive output 324 may include a numerical, floating point value indicative of a predicted likelihood that user 119 will be associated with a default event involving the credit-card account during a future, twelve-month interval (e.g., based on the application of the trained, gradient-boosted, decision-tree process to input dataset 322). Further, and as described herein, the elements of explainability data 326 may include one or more Shapley feature values that characterize a relative of importance of each, or subset, of the discrete features within input dataset 322 on predictive output 324 and additionally, or alternatively, values of one or more deterministic or probabilistic metrics that characterize the relative importance of discrete features within input dataset 322, such as those described herein. Furthermore, the elements of explainability data may also be formatted or structured in accordance with a file format, e.g., a DOCX format, consistent with the inferencing preferences of the business unit associated with computing system 102.

In some instances, executed post-processing module 148 may also perform operations that obtain, from configuration data store 150, one or more elements of modified post-processing configuration data 226, which may be customized to reflect the data one or more post-processing preferences of the business unit associated with computing system 102. For example, and as described herein, modified post-processing configuration data 226 may define one or more post-processing operations applicable to predictive output 324 or the elements of explainability data 326, such as, but not limited to a post-processing operation that scales of the floating-point value within predictive output 324 from zero (e.g., indicating a minimal likelihood of an occurrence of the default event within the future, twelve-month interval) and unity (e.g., indicating a maximum likelihood of an occurrence of the default event within the future, twelve-month interval). The elements of modified post-processing configuration data 226 may also include, among other things, parameter values that characterize one or more of the post-processing operations, data characterizing an order of sequential, or parallel, application of the post-processing operations to the elements of inferencing output data, such as, but not limited to, predictive output 324 and the elements of explainability data 326 described herein, and additionally, or alternatively, a structure, composition, or format of a desired response to real-time inferencing request 308.

Further, executed post-processing module 148 may perform operations that obtain post-processing script 178 from script data store 170, and once processed and executed, post-processing script 178 may cause executed post-processing module 148 to perform operations that apply the scaling operation defined within the elements of modified post-processing configuration data 226 to the floating-point value within predictive output 324 (e.g., to scale the floating-point value from zero to unity), and that generate post-processed predictive output 330 that includes the scaled floating point value indicative of a predicted likelihood that user 119 will be associated with a default event involving the credit-card account during a future, twelve-month interval. Additionally, once processed and executed, post-processing script 178 may also cause executed post-processing module 148 to perform operations that package all, or a selected portion, of post-processed predictive output 330 and the elements of explainability data 326 into corresponding portions of a response 332 to real-time inferencing request 308, which may be characterized by a structure or format consistent with one or more post-processing preferences of the business unit associated with computing system 102.

Executed real-time inferencing application 138 may also perform operations that cause FI computing system 130 to transmit response 332, including all, or the selected portion, of post-processed predictive output 330 and the elements of explainability data 326, across communications network 120 to computing system 102. In some instances, FI computing system 130 may perform any of the exemplary processes described herein to generate response 332 to real-time inferencing request 308 and transmit response 332 across communications network 120 to computing system 102, and computing system 102 may receive response 332 to real-time inferencing request 308, in real-time and contemporaneously with a receipt of real-time inferencing request 308 at FI computing system 130, e.g., within a predetermined, threshold temporal interval of the receipt of real-time inferencing request 308 at FI computing system 130. Examples of the predetermined, threshold temporal interval may include, but are not limited to, thirty seconds, one minute, ninety seconds, two minutes, or three minutes.

Referring back to FIG. 3C, a programmatic interface associated with executed decisioning application 110, such as, application programming interface (API) 334, may receive response 332, including post-processed predictive output 330 and the elements of explainability data 326, and may route response 332 to executed decisioning application 110, which may store response 332 in a portion of memory 104, e.g., in conjunction with application data 302. In some instances, executed decisioning application 110 may perform operations that determine whether to pre-approve, or decline, the application of user 119 for the credit-card account based on the elements of application data 302, which characterize the application of user 119 for the credit-card account, the elements of post-processed predictive output 330, which includes a scaled floating point value indicative of a predicted likelihood that user 119 will be associated with a default event involving the credit-card account during a future, twelve-month interval, and the elements of explainability data 326.

By way of example, executed decisioning application 110 may elect to pre-approve, or decline, the application of user 119 for the credit-card account based on application of one or more pre-approval criteria to the scaled floating-point value within post-processed predictive output 330 and additionally, or alternatively, to portions of application data 302. For instances, the one or more pre-approval criteria may specify a threshold value for the scaled floating-point value, which be static or be determined based on the elements of application data 302, and executed decisioning module pre-approve the application of user 119 for the credit-card account when the scaled floating-point value, which indicates the predicted likelihood that user 119 will be associated with the default event involving the credit-card account during the future, twelve-month interval, fails to exceed the threshold value, e.g., 0.25.

If, for example, executed decisioning application 110 elects to pre-approve the application of user 119 for the credit-card account based on a determination that the scaled floating-point value fails to exceed the threshold value, executed decisioning application 110 may generate elements of real-time decision data 334 that confirms the decision to pre-approve the application and that includes additional information, such as a hyperlink to a web page or a deep-link digital interface generated mobile banking application, that instructs user 119 to provide further application information or credentials as inputs to the financial institution, which may complete the approval process and cause the financial institution to fund the approved application. Executed decisioning application 110 may store the elements of real-time decision data 334 in a corresponding portion of memory 104, e.g., in conjunction with application data 302 and response 332, and may perform operations that cause computing system 102 to transmit the elements of real-time decision data 334 across communications network 120 to client device 118, which may process the elements of real-time decision data 334 and perform operations that present data confirming the pre-approval of the application for the credit-card account within a corresponding digital interface (not illustrated in FIG. 3C).

Alternatively, if executed decisioning application 110 were to decline the application of user 119 for the credit-card account based on a determination that the scaled floating-point value exceeds the threshold value, executed decisioning application 110 may generate additional elements of real-time decision data 334 that confirm the decision to decline the application. In some instances, responsive to the decision to decline the application, executed decisioning application 110 may access the elements of explainability data 326, and determine a threshold set of features, such as, but not limited to, a total balance of revolving credit held by user 119, that are associated with maximum Shapley feature values and as such, a maximum relative impact on the predictive output of the real-time inferencing processes. Executed decisioning application 110 may package information characterizing these impactful features into the elements of real-time decision data 334 (e.g., as “reasons” for the declined application), and may store the elements of additional elements of real-time decision data 334 in a corresponding portion of memory 104, e.g., in conjunction with application data 302 and response 332. Further, executed decisioning application 110 may also perform operations that cause computing system 102 to transmit the additional elements of real-time decision data 334 across communications network 120 to client device 118, which may process the additional elements of real-time decision data 334, and perform operations that present data confirming the decline of the application for the credit-card account, and in some instances, the reasons for the decision, within a corresponding digital interface (not illustrated in FIG. 3C).

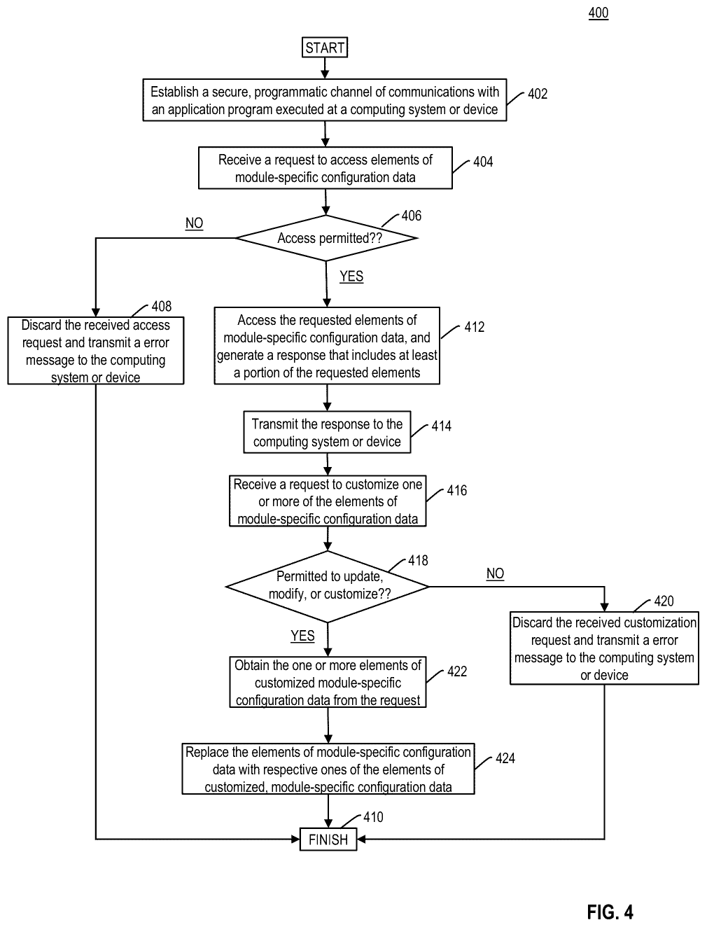

FIG. 4 is a flowchart of an exemplary process 400 for customizing a sequential, pipelined execution of real-time inferencing processes within a distributed computing environment. In some examples, one or more computing systems associated with a financial institution, such as one or more of the distributed computing components of FI computing system 130, may perform one or more of the steps of exemplary process 400, as described herein.

Referring to FIG. 4, the one or more distributed computing components of FI computing system 130 may perform operations, described herein, to establish a secure, programmatic channel of communications across communications network 120 with an application program executed at a computing system or device (e.g., in step 402 of FIG. 4). In some instances, computing system or device may be associated with, or operable by, a business unit of the financial institution associated with FI computing system 130 (e.g., computing system 102 of FIG. 1), and the one or more distributed computing components of FI computing system 130 may execute a programmatic web server, such programmatic web server 140 of FIG. 1, which may perform any of the exemplary processes described herein to establish the secure, programmatic channel of communications across communications network 120 with a web browser or other application program (e.g., web browser 108 of FIG. 1) executed by computing system 102 in accordance with one, or more, appropriate communications protocols, such as, but not limited to, a hypertext transfer protocol (HTTP), a transmission control protocol (TCP), or an internet protocol (IP).

In some examples, the real-time inferencing processes may include discrete data-processing, feature-engineering, inferencing, and post-processing operations, each of which may be associated with, and implemented by, a corresponding application module, e.g., a corresponding one of payload processing module 142, data-preparation module 144, inferencing module 146, and post-processing module 148. As described herein, the distributed computing components of FI computing system 130 may establish a generalized, modular computational framework that executes sequentially each of the payload processing module 142, data-preparation module 144, inferencing module 146, and post-processing module 148 in accordance with an executed static master script, and additionally, or alternatively, in accordance with corresponding, executed status module-specific scripts, and further, based on corresponding elements of module-specific configuration data (e.g., corresponding elements of payload configuration data 152, data-preparation configuration data 154, inferencing configuration data 156, and post-processing configuration data 158 maintained within configuration data store of FIG. 1). The distributed computing components of FI computing system may, for example, maintain the static module-specific scripts, within a portion of one or more tangible, non-transitory memories that is inaccessible to computing system 102 via the secure, programmatic channel of communications (e.g., within an inaccessible partition of a Hadoop™ distributed file system (HDFS)), and may maintain the elements of module-specific configuration data within a portion of the one or more tangible, non-transitory memories that is accessible to computing system 102 via the secure, programmatic channel of communications (e.g., within an accessible partition of the HDFS).

Referring back to FIG. 4, the one or more distributed computing components of FI computing system 130 may receive, from computing system 102, a request to access each, or a selected subset, of the elements of module-specific configuration data maintained within configuration data store 150, such as, but not limited to, the elements of payload configuration data 152, data-preparation configuration data 154, inferencing configuration data 156, and post-processing configuration data 158 (e.g., in step 404 of FIG. 4). In some instances, the one or more distributed computing components of FI computing system 130 may receive the access request from computing system 102 across communications network 120 via the established, secure, programmatic channel of communications using one or more appropriate communications protocols.

The received access request may include, among other things, one or more identifiers of computing system 102 or executed web browser 108, such as, but not limited to, an IP address of computing system 102, a media access control (MAC) address assigned to computing system 102, or a digital token or application cryptogram identifying executed web browser 108 (e.g., a digital token or application cryptogram generated or received while establishing the secure, programmatic channel of communications with executed programmatic web server 140). The received access request may also include data identifying each, or a selected subset, of the elements of module-specific configuration data maintained within configuration data store 150 and subject to the requested access, e.g., a unique, alphanumeric identifier of each, or a selected subset, of payload configuration data 152, data-preparation configuration data 154, inferencing configuration data 156, and post-processing configuration data 158.

In some instances, the one or more distributed computing components of FI computing system 130 may perform any of the exemplary processes described herein to determine whether a source of the access request is permitted to access the elements of module-specific configuration data maintained within configuration data store 150 (e.g., in step 406 of FIG. 4). For example, in step 406, the one or more distributed computing components of FI computing system 130 may obtain, from the access request, the one or more identifiers of computing system 102 or executed web browser 108, such as, but not limited to, the IP or MAC address of computing system 102 or the digital token or application cryptogram identifying executed web browser 108, The one or more distributed computing components of FI computing system 130 may also perform operations, in step 406, that determine, based on the one or more identifiers of computing system 102 or executed web browser 108, whether FI computing system 130 grants computing system 102 or executed web browser 108 permission to access the elements of module-specific configuration data (e.g., based on a comparison of the one or more identifiers against a compiled list of blocked computing devices, computing systems, or application programs).

If the one or more distributed computing components of FI computing system 130 were to determine that computing system 102, or executed web browser 108, is not permitted to access the requested elements of module-specific configuration data (e.g., step 406; NO), the one or more distributed computing components of FI computing system 130 may discard the received access request and may perform operations that transmit an error message to computing system 102 (e.g., in step 408 of FIG. 4). Exemplary process 400 is then complete in step 410.

Alternatively, if the one or more distributed computing components of FI computing system 130 to establish that computing system 102 and executed web browser 108 are permitted to access the requested elements of module-specific configuration data (e.g., step 406; YES), the one or more distributed computing components of FI computing system 130 may perform any of the exemplary processes described herein to access the requested elements of module-specific configuration data (e.g., one or more of payload configuration data 152, data-preparation configuration data 154, inferencing configuration data 156, and post-processing configuration data 158 maintained within configuration data store 150), and generate a response to the access request that includes at least a portion of the requested elements of module-specific configuration data (e.g., in step 412 of FIG. 4). The distributed computing components of FI computing system 130 may also perform operations, in step 414 of FIG. 4, that transmit the generated response to the access request across communications network 120 to computing system 102, e.g., across the established, secure programmatic channel of communications.

In some instances, computing system 102 may receive the response to the access request from the one or more distributed computing components of FI computing system 130, and one or more application programs executed by computing system 102, such as executed web browser 108, may access the received response and perform operations that obtain, from the received response, at least the portion of the requested elements of module-specific configuration data (e.g., at least a portion of the elements of payload configuration data 152, data-preparation configuration data 154, inferencing configuration data 156, and post-processing configuration data 158). As described herein, the received response may include each of the requested elements of module-specific configuration data (e.g., structured in Python™-compatible, human-readable data-serialization language, such as a YAML™ data-serialization language), and executed web browser 108 may perform any of the exemplary processes to process the requested elements of module-specific configuration data, generate corresponding interface elements that provide a graphical or textual representation of the requested elements of module-specific configuration data, and render the generate interface elements for presentation within one or more display screens of a digital interface.

Further, and as described herein, the received response may also include hyperlinks or other elements of data that identify, or point to, the location of each of the requested elements of module-specific configuration data within the one or more tangible, non-transitory memories of FI computing system 130. Executed web browser 108 may obtain the hyperlinks or other elements of pointer data from the received response, and may perform operations, based on the hyperlinks or other elements of pointer data, that request and receive corresponding ones of the elements of module-specific configuration data across communications network 120 from the one or more distributed computing components of FI computing system 130. Further, executed web browser 108 may perform any of the exemplary processes described herein to process the received elements of module-specific configuration data, generate additional, or alternate, interface elements that provide a graphical or textual representation of the received elements of module-specific configuration data, and render the additional, or alternate, interface elements for presentation within one or more display screens of a digital interface.

In some instances, the business unit associated with computing system 102 may elect to update, modify, or customize one or more of the elements of the module-specific configuration data, such as, but not limited to, one or more of the elements of payload configuration data 152, data-preparation configuration data 154, inferencing configuration data 156, and post-processing configuration data 158, to reflect corresponding ones of a data pre-processing preference, a feature-engineering preference, an inferencing preference, or a data post-processing preference of the business unit. By way of example, and as described herein, the data pre-processing, feature-engineering, inferencing, or data post-processing preferences of the business unit may be associated with, and may facilitate, a particular application or use-case of the real-time inferencing processes and a corresponding target of these real-time inferencing processes (e.g., predicting, in real-time, a likelihood that a customer of the financial institution will be involved in a default event involving a credit-card account during a predetermined, future target interval, etc.).

As described herein, and based on the displayed interface elements, an operator of computing system 102, such as analyst 103, may provision input to computing system 102 (e.g., via input unit 116 of FIG. 1) that updates, modifies, or customizes one or more of the elements of module-specific configuration data in accordance with the one, or more, of the data pre-processing, feature-engineering, inferencing, or data post-processing preferences of the business unit. Based on the received input, executed web browser 108 may perform any of the exemplary processes described herein to generate corresponding elements of customized, module-specific configuration data, e.g., elements of modified payload configuration data 220, modified data-preparation configuration data 222, modified inferencing configuration data 224, and/or modified post-processing configuration data 226. Executed web browser 108 may also perform operations, described herein, that package each of the elements of customized, module-specific configuration data into corresponding portions of a customization request, along with one or more identifiers of computing system 102 or executed web browser 108, such as, but not limited to, the IP or MAC address of computing system 102 and/or the digital token or application cryptogram identifying executed web browser 108. Executed web browser 108 may transmit the customization request across communications network 120 to the one or more distributed computing components of FI computing system 130, e.g., via the established, secure, programmatic channel of communications.

Referring back to FIG. 4, the one or more distributed computing components of FI computing system 130 may receive the customization request across communications network 120 from computing system 102 (e.g., in step 416 of FIG. 4). In some instances, the one or more distributed computing components of FI computing system 130 may receive the customization request from computing system 102 across communications network 120 via the established, secure, programmatic channel of communications using one or more appropriate communications protocols.

As described herein, the customization request may include, among other things, one or more identifiers of computing system 102 or executed web browser 108, such as, but not limited to, the IP or MAC address of computing system 102 and/or the digital token or application cryptogram identifying executed web browser 108. The received customization request may also include the one or more elements of customized, module-specific configuration data (e.g., elements of modified payload configuration data 220, modified data-preparation configuration data 222, modified inferencing configuration data 224, and/or modified post-processing configuration data 226), which reflect one, or more, of the data pre-processing, feature-engineering, inferencing, or data post-processing preferences of the business unit and/or the particular application or use-case of the real-time inferencing processes.

In some instances, the one or more distributed computing components of FI computing system 130 may perform any of the exemplary processes described herein to determine whether a source of the customization request is permitted to update, modify, or customize the elements of module-specific configuration data maintained within configuration data store 150 (e.g., in step 418 of FIG. 4). For example, in step 418, the one or more distributed computing components of FI computing system 130 may obtain, from the access request, the one or more identifiers of computing system 102 or executed web browser 108, such as, but not limited to, the IP or MAC address of computing system 102 or the digital token or application cryptogram identifying executed web browser 108, The one or more distributed computing components of FI computing system 130 may also perform operations, in step 418, that determine, based on the one or more identifiers of computing system 102 or executed web browser 108, whether FI computing system 130 grants computing system 102 or executed web browser 108 permission to update, modify, or customize the elements of module-specific configuration data (e.g., based on a comparison of the one or more identifiers against a compiled list of blocked computing devices, computing systems, or application programs).

If the one or more distributed computing components of FI computing system 130 were to determine that computing system 102, or executed web browser 108, is not permitted to update, modify, or customize the elements of module-specific configuration data (e.g., step 418; NO), the one or more distributed computing components of FI computing system 130 may discard the received customization request and may perform operations that transmit an error message to computing system 102 (e.g., in step 420 of FIG. 4). Exemplary process 400 is then complete in step 410.

Alternatively, if the one or more distributed computing components of FI computing system 130 to establish that computing system 102 and executed web browser 108 are permitted to update, modify, or customize the elements of module-specific configuration data (e.g., step 418; YES), the one or more distributed computing components of FI computing system 130 may perform any of the exemplary processes described herein to obtain from the received customization request, the one or more elements of customized, module-specific configuration data (e.g., in step 422 of FIG. 4). As described herein, the one or more elements of customized, module-specific configuration data (e.g., the elements of modified payload configuration data 220, modified data-preparation configuration data 222, modified inferencing configuration data 224, and/or modified post-processing configuration data 226), which reflect one, or more, of the data pre-processing, feature-engineering, inferencing, or data post-processing preferences of the business unit and the particular application or use-case of the real-time inferencing processes.

The one or more distributed computing components of FI computing system 130 may also access the elements of module-specific configuration data maintained within the one or more tangible, non-transitory memories of FI computing system 130, and may perform any of the exemplary processes described herein to replace (or modify) the elements of module-specific configuration data with (or in accordance with) respective ones of the elements of customized, module-specific configuration data (e.g., in step 424 of FIG. 4). By way of example, and as described herein, the one or more distributed computing components of FI computing system 130 may access configuration data store 150 maintained within data repository 132, and perform operations that replace, or modify, the elements of payload configuration data 152, data-preparation configuration data 154, inferencing configuration data 156, and post-processing configuration data 158 based on, and on accordance with, corresponding ones of the elements of modified payload configuration data 220, the elements of modified data-preparation configuration data 222, the elements of modified inferencing configuration data 224, the elements of modified post-processing configuration data 226.

In some instances, through a customization of one or more of the module-specific elements of configuration data to reflect the one or more pre-processing, feature-engineering, inferencing, or post-processing preferences of the business unit associated with computing system 102, and additionally or alternatively, to reflect a use-case of the real-time inferencing processes of relevance to the business unit, one or more of the exemplary processes described herein may enable the business unit (via computing system 102) to customize the sequential, pipelined execution of the application modules and receive, in real-time, transformed elements of predictive output consistent with the preferences of the business unit, and with the use-case of the real-time inferencing processes of relevance of the business unit, without modification, by computing system 102, to the elements of underlying code executed by the one or more distributed computing components of FI computing system 130. Exemplary process 400 is then complete in step 410.

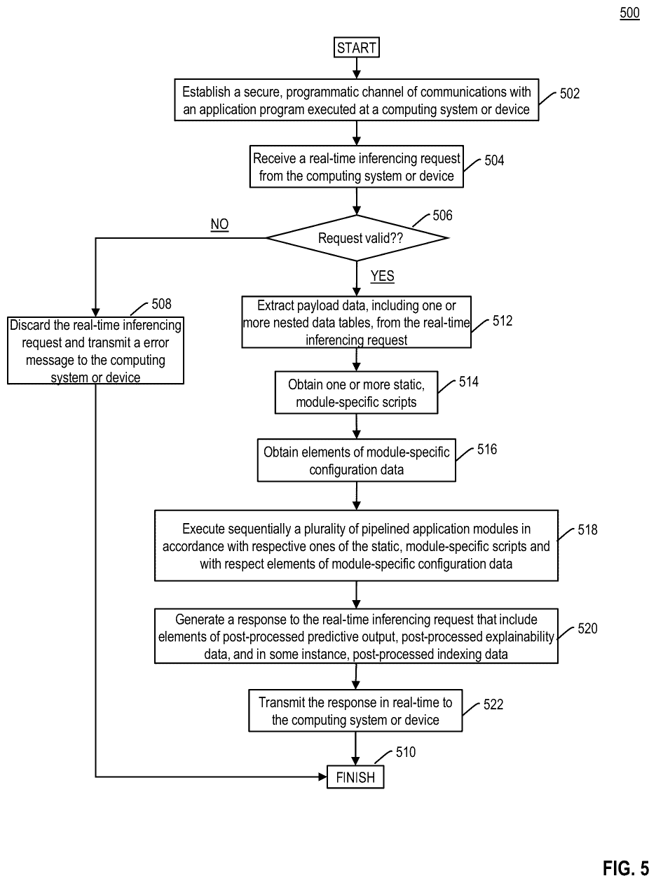

FIG. 5 is a flowchart of an exemplary process 500 for executing pipelined, real-time inferencing processes within a distributed computing environment. In some examples, one or more computing systems associated with a financial institution, such as one or more of the distributed computing components of FI computing system 130, may perform one or more of the steps of exemplary process 500, as described herein.

Referring to FIG. 5, the one or more distributed computing components of FI computing system 130 may perform operations, described herein, to establish a secure, programmatic channel of communications across communications network 120 with an application program executed at a computing system or device (e.g., in step 502 of FIG. 5). In some instances, computing system or device may be associated with, or operable by, a business unit of the financial institution associated with FI computing system 130 (e.g., computing system 102 of FIG. 1), and the one or more distributed computing components of FI computing system 130 may execute a programmatic web server, such programmatic web server 140 of FIG. 1, which may perform any of the exemplary processes described herein to establish the secure, programmatic channel of communications across communications network 120 with an application program (e.g., decisioning application 110) executed by computing system 102 in accordance with one, or more, appropriate communications protocols, such as, but not limited to, a hypertext transfer protocol (HTTP), a transmission control protocol (TCP), or an internet protocol (IP).

The one or more distributed computing components of FI computing system 130 may also receive a real-time inferencing request from computing system 102 across communications network 120 (e.g., in step 504 of FIG. 5). In some instances, the real-time inferencing request may be generated by one or more application programs executed by computing systems, such as executed decisioning application 110, and the one or more distributed computing components of FI computing system 130 may receive the real-time inferencing request from computing system 102 via the established, secure programmatic channel of communications.

In some instances, real-time inferencing request may be associated with a request to initiate an sequential execution, in real-time, of a plurality of inferencing processes, which may generate elements of predictive output that inform one or more real-time decisioning processes implemented by computing system 102, such as, but not limited to, the exemplary, real-time processes for pre-approving applications for credit-card account, for pre-approving applications for secured lending products, and/or identifying potentially fraudulent transactions described herein. Further, and as described herein, the real-time inferencing processes may include discrete data-processing, feature-engineering, inferencing, and post-processing operations, each of which may be associated with, and implemented by, a corresponding application module, e.g., a corresponding one of payload processing module 142, data-preparation module 144, inferencing module 146, and post-processing module 148 of FIG. 1.

The distributed computing components of FI computing system 130 may, for example, establish a generalized, modular and configurable computational framework that executes sequentially each of the payload processing module 142, data-preparation module 144, inferencing module 146, and post-processing module 148 in accordance with an executed static master script, and additionally, or alternatively, in accordance with corresponding, executed, static, module-specific scripts, and further, based on corresponding elements of module-specific configuration data (e.g., corresponding elements of payload configuration data 152, data-preparation configuration data 154, inferencing configuration data 156, and post-processing configuration data 158 maintained within configuration data store 150). Further, and using any of the exemplary processes described herein, computing system 102, and the distributed computing components of FI computing system 130, may perform operations that update, modify, or customize one or more of the elements of the module-specific configuration data, such as, but not limited to, one or more of the elements of payload configuration data 152, data-preparation configuration data 154, inferencing configuration data 156, and post-processing configuration data 158, to reflect corresponding ones of a data pre-processing preference, a feature-engineering preference, an inferencing preference, or a data post-processing preference of the business unit. By way of example, and as described herein, the data pre-processing, feature-engineering, inferencing, or data post-processing preferences of the business unit may be associated with a particular application or use-case of the requested real-time inferencing processes and a corresponding, business-unit-specific target of these real-time inferencing processes.

In some instances, the received, real-time inferencing request may include, among other things, one or more identifiers of computing system 102 or executed decisioning application 110, elements of inferencing data that characterize the requested, real-time inferencing processes, and elements of payload data. The one or more identifiers of computing system 102 or executed decisioning application 110 may include, but are not limited to, the IP or MAC address of computing system 102 or a digital token or application cryptogram identifying executed decisioning application 110 (e.g., a digital token or application cryptogram generated or received while establishing the secure, programmatic channel of communications with executed programmatic web server 140). Further, the elements of inferencing data may, among other things, identify or characterize a trained machine-learning or artificial-intelligence process associated with the requested, real-time inferencing operations (e.g., an alphanumeric identifier of an identifier of a trained, gradient-boosted, decision-tree process, such as a trained XGBoost process), and in some instances, may also define the business-unit-specific target of the requested, real-time inferencing processes.

By way of example, the target of the requested, real-time inferencing process may inform one or more decisioning processes implemented by computing system 102. For instance, and as described herein, computing system 102 may perform operations that pre-approve or alternatively, decline, in real-time an application for a credit card account by an existing or prospective customer of the financial institution, and the elements of inferencing data may define the target of the requested, real-time inferencing processes as a predicted likelihood that a customer will be associated with a default event involving a credit-card account during a predetermined, future target interval, as described herein), and may specify the target future interval (e.g., a future, twelve-month interval, etc.). In some instances, computing system 102 may generate the elements of inferencing data during a performance of one or more of the exemplary processes described herein that update, modify, or customize one or more of the elements of the module-specific configuration data to reflect corresponding ones of a data pre-processing preference, a feature-engineering preference, an inferencing preference, or a data post-processing preference of the business unit.

Further, the elements of payload data may include one or more nested data tables identifying and characterizing one or more customers of the financial institution, and the interactions of these customers with the financial institution and with unrelated financial institutions or other entities in the financial services industry By way of example, and as described herein, the one or more nested data tables may include one or more elements of customer-profile, account, transaction, and/or credit bureau data characterizing the existing or prospective customer of the financial institution associated with the requested, real-time inferencing processes (e.g., and having primary key indices that include an alphanumeric customer identifier), and each of the nested data tables may be may be formatted or structured in a standardized data-exchange format, such as JSON™ or an extensible markup language (XML), and executed decisioning application 110 may perform operations that package one, or multiple, nested data tables 304 within a payload 306 of a real-time inferencing request 308.

Referring back to FIG. 5, the one or more distributed computing components of FI computing system 130 may perform operations, described herein, that validate the elements of the received, real-time inferencing request (e.g., in step 506 of FIG. 5). By way of example, within step 506, the one or more distributed computing components of FI computing system 130 may perform any of the exemplary processes described herein to: (i) process the received, real-time request and determine whether a structure, format, or composition of the received, real-time inferencing request is consistent with an expected structure, format, or composition of requests from computing systems associated with the business units of the financial institution; (ii) based on the one or more identifiers of computing system 102 or executed decisioning application 110 within the received, real-time inferencing request, determine whether computing system 102 and/or executed decisioning application 110 are permitted to request real-time inferencing processes; and (iii) based on the elements of inferencing data within the received, real-time inferencing request, determine whether the requested, real-time inferencing processes are within the scope of the trained machine-learning or artificial intelligence processes available at FI computing system 130.

If, for example, the one or more distributed computing components of FI computing system 130 were to determine that the structure, format, or composition of the received, real-time inferencing request is inconsistent with the expected structure, format, or composition, that computing system 102 and/or executed decisioning application 110 are not permitted to request real-time inferencing processes, or that the requested, real-time inferencing processes fall outside the scope of the available the trained machine-learning or artificial intelligence processes, the one or more distributed computing components of FI computing system 130 may decline to validate the received, real-time inferencing request (e.g., step 506; NO), and the one or more distributed computing components of FI computing system 130 may discard the received, real-time inferencing request and may perform operations that transmit an error message to computing system 102 (e.g., in step 508 of FIG. 5). Exemplary process 500 is then complete in step 510

Alternatively, if the one or more distributed computing components of FI computing system 130 were to determine that the structure, format, or composition of the received, real-time inferencing request is consistent with the expected structure, format, or composition, that computing system 102 and/or executed decisioning application 110 are permitted to request real-time inferencing processes, and that the requested, real-time inferencing processes fall within the scope of the available the trained machine-learning or artificial intelligence processes, the one or more distributed computing components of FI computing system 130 may validate the received, real-time inferencing request (e.g., step 506; YES), the one or more distributed computing components of FI computing system 130 may perform operation that extract the elements of payload data, including the nested data tables, from the received, real-time inferencing request (e.g., in step 512 of FIG. 5).

The one or more distributed computing components of FI computing system 130 may also perform operations, described herein, that obtain one or more static, module-specific scripts that, when executed by the one or more distributed computing components of FI computing system 130, facilitate a performance of the requested real-time inferencing processes and the sequential, pipelined execution of corresponding ones of payload processing module 142, data-preparation module 144, inferencing module 146, and post-processing module 148 of real-time inferencing application 138 (e.g., in step 514 of FIG. 5). By way of example, in step 514, the one or more distributed computing components of FI computing system 130 may access script data store 170 of data repository 132, and obtain payload script 172, data-preparation script 174, inferencing script 176, and post-processing script 178.

The one or more distributed computing components of FI computing system 130 may also perform operations, described herein, that obtain one or more elements of module-specific configuration data associated with corresponding ones of payload processing module 142, data-preparation module 144, inferencing module 146, and post-processing module 148 (e.g., in step 516 of FIG. 5). By way of example, in step 516, the one or more distributed computing components of FI computing system 130 may access configuration data store 150 of data repository 132, and obtain elements of elements of modified payload configuration data 220, modified data-preparation configuration data 222, modified inferencing configuration data 224, and modified post-processing configuration data 226 associated with corresponding ones of payload processing module 142, data-preparation module 144, inferencing module 146, and post-processing module 148. In some instances, described herein, the elements of module-specific configuration data (e.g., elements of elements of modified payload configuration data 220, modified data-preparation configuration data 222, modified inferencing configuration data 224, and modified post-processing configuration data 226) may be customized to corresponding ones of a data pre-processing preference, a feature-engineering preference, an inferencing preference, or a data post-processing preference of the business unit, which may reflect a particular application or use-case of the requested real-time inferencing processes and a corresponding, business-unit-specific target of these real-time inferencing processes.

In some instances, the one or more distributed computing components of FI computing system 130 may perform operations, described herein, to sequentially execute payload processing module 142, data-preparation module 144, inferencing module 146, and post-processing module 148 in accordance with the respective ones of payload script 172, data-preparation script 174, inferencing script 176, and post-processing script 178, and in accordance with respective ones of modified payload configuration data 220, modified data-preparation configuration data 222, modified inferencing configuration data 224, and modified post-processing configuration data 226 (e.g., in step 518 of FIG. 5). By way of example, in step 518, the one or more distributed computing components of FI computing system 130 may execute payload processing module 142 in accordance with payload script 172 and with modified payload configuration data 220. Executed payload processing module 142 may perform any of the exemplary processes described herein to access the elements of payload data, extract the nested data tables from the elements of payload data, and confirm that each of the nested data tables includes the primary key index or indices, such as, but not limited to, the alphanumeric customer identifier. Further, executed payload processing module 142 may perform any of the exemplary processes described herein to apply sequentially each of the data pre-processing operations specified within the elements of modified payload configuration data 220 to the nested data tables, and to generate elements of structured and indexed data that include the elements of “flattened” tabular data and in some instances, indexing data.

The one or more distributed computing components of FI computing system 130 may also execute data-preparation module 144 in accordance with data-preparation script 174 and with the elements of modified data-preparation configuration data 222 (e.g., also in step 518 of FIG. 5). In some instances, executed data-preparation module 144 may access the elements of structured and indexed data, and in some instances, the indexing data, generated by executed payload processing module 142, and may perform any of the exemplary processes described herein to: (i) one or more feature-engineering operations to the elements of structured and indexed data in accordance with corresponding sequence and parameter values specified within the elements of modified data-preparation configuration data 222; (ii) generate a corresponding feature value based on the application of the feature-engineering operations to the elements of structured and indexed data; and (iii) store the corresponding feature values at a sequential position within an input dataset specified with the elements of modified data-preparation configuration data 222. As described herein, the input dataset may be characterized by a structure or a format consistent with the data-preparation preferences of the business unit associated with computing system 102, such as, but not limited to, the Python™-compatible pandas dataframe described herein.

Further, the one or more distributed computing components of FI computing system 130 may also execute inferencing module 146 in accordance with inferencing script 176 and with the elements of modified inferencing configuration data 224 (e.g., also in step 518 of FIG. 5). In some instances, executed data-preparation module 144 may access the input dataset, which includes one or more feature values disposed at corresponding sequential positions within the input dataset, and which may be formatted and structured as a Python™-compatible pandas dataframe. In some instances, executed inferencing module 146 may also perform operations that obtain, from configuration data store 150, one or more elements of modified inferencing configuration data 224, which may be customized to reflect the data one or more inferencing preferences of the business unit associated with computing system 102 using any of the exemplary processes described herein.

Executed inferencing module 146 may also perform operations that obtain, from the elements of elements of modified inferencing configuration data 224, an identifier of the trained machine-learning or artificial-intelligence process associated with the requested, real-time inferencing processes (e.g., the alphanumeric identifier of a trained, gradient-boosted, decision-tree process, such as the trained XGBoost process), and based on the identifier, executed inferencing module 146 may perform operations that obtain values of one or more process parameters associated with the trained machine-learning or artificial-intelligence process consistent with the inferencing preferences of the business unit associated with computing system 102 (e.g., as trained process parameters 160).

Executed inferencing module 146 may also perform any of the exemplary processes described herein to establish the trained machine-learning or artificial-intelligence process based on the obtained process parameter values, and to apply the trained machine-learning or artificial-intelligence process to input dataset. Further, and based on the application of the trained machine-learning or artificial-intelligence process to the input dataset, executed inferencing module 146 may also perform any of the exemplary processes described herein to generate predictive output structured or formatted in accordance with the elements of modified inferencing configuration data 224, to generate one or more elements of explainability data that characterize predictive output or an impact of each, or a selected subset of, the feature values maintained within the input dataset on the predictive output, and in some instances, to generate one or more elements of indexing data that index the corresponding elements of predictive output data and explainability data in accordance with a corresponding primary key index or primary key indices. As described herein, executed inferencing module 146 may also perform operations that package the predictive output, explainability data, and indexing data into corresponding portions of inferencing output data.

Further, one or more distributed computing components of FI computing system 130 may also execute post-processing module 148 in accordance with post-processing script 178 and with the elements of modified post-processing configuration data 226 (e.g., also in step 518 of FIG. 5). In some instances, executed post-processing module 148 may access inferencing output data, which includes the predictive output, the elements of explainability data, and in some instances, the elements of indexing data, and executed post-processing module 148 may perform any of the exemplary processes described herein to apply one or more post-processing operations to the predictive output, the elements of explainability data, and/or the elements of indexing data in accordance with the elements of modified post-processing configuration data 226. Based on the application of the one or more post-processing operations to the predictive output, the elements of explainability data, and/or the elements of indexing data, executed post-processing module 148 may generate, as outputs of the requested, real-time inferencing processes, post-processed predictive output, explainability data, and in some instances, indexing data consistent with the data pre-processing, feature-engineering, inferencing, or data post-processing preferences of the business unit, which may be associated with a particular application or use-case of the requested real-time inferencing processes and a corresponding, business-unit-specific target of these real-time inferencing processes.

Referring back to FIG. 5, the distributed computing components of FI computing system 130 may also perform operations that package all, or a selected subset, of the elements of post-processed predictive output, explainability data, and in some instances, indexing data into corresponding portions of a response to the received, real-time inferencing request (e.g., in step 520 of FIG. 5). In some instances, described herein, executed post-processing module 148 may perform operations, consistent with post-processing script 178 and with the elements of modified post-processing configuration data 226, that generate package all, or the selected subset, of post-processed predictive output, explainability data, and/or indexing data into the corresponding portions of the response.

The distributed computing components of FI computing system 130 may also perform operations that transmit the response, which includes all, or the selected subset, of the elements of post-processed predictive output, explainability data, and/or indexing data, across communications network 120 to computing system 102. In some instances, the distributed computing components of FI computing system 130 may perform any of the exemplary processes described herein to generate the response to the real-time inferencing request and transmit the response across communications network 120 to computing system 102, and computing system 102 may receive the response to the real-time inferencing request, in real-time and contemporaneously with a receipt of the real-time inferencing request at FI computing system 130, e.g., within a predetermined, threshold temporal interval of the receipt of the real-time inferencing request at FI computing system 130. Examples of the predetermined, threshold temporal interval may include, but are not limited to, thirty seconds, one minute, ninety seconds, two minutes, or three minutes. Exemplary process 500 is then complete in step 510

### C. Exemplary Hardware and Software Implementations

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including web browser, decisioning application 110, validation application 136, real-time inferencing application 138, web service 140, payload processing module 142, data-preparation module 144, inferencing module 146, post-processing module 148, web framework 202, customization application programming interface (API) 204, validation API 314, and real-time inferencing API 314, can be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination thereof.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as, but not limited to, a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with user 119, such as a customer, of client device 118, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. An apparatus, comprising:
a communications interface;
a memory storing instructions; and
at least one processor coupled to the communications interface and to the memory, the at least one processor being configured to execute the instructions to:
receive an inferencing request from a computing system via the communications interface, the inferencing request comprising elements of payload data, and the inferencing request being associated with an application, in real-time, of a trained machine-learning or artificial intelligence process to an input dataset;
based on the inferencing request, obtain configuration data associated with the trained machine-learning or artificial intelligence process, the configuration data being generated by the computing system;
perform operations that (i) generate the input dataset based on an application of one or more feature-engineering operations to the elements of payload data in accordance with a first portion of the configuration data, and (ii) generate output data based on the application, in real-time, of the trained machine-learning or artificial intelligence process to the input dataset; and
transmit, to the computing system via the communications interface, a response to the inferencing request that includes at least at least a portion of the output data.

2. The apparatus of claim 1, wherein the at least one processor is further configured to execute the instructions to:
receive, via the communications interface, the configuration data from the computing system; and
store the configuration data within a portion of the memory, the portion of the memory being accessible to the computing system.

3. The apparatus of claim 1, wherein the at least one processor is further configured to execute the instructions to:
obtain one or more elements of nested tabular data from the elements of payload data;
based on at least a second portion of the configuration data, apply at least one pre-processing operation to the one or more elements of nested tabular data, and generate elements of pre-preprocessed tabular data based on the application of the least one pre-processing operation to the one or more elements of nested tabular data; and
perform additional operations that generate the input dataset based on an application of the one or more feature-engineering operations to the elements of pre-preprocessed tabular data in accordance with the first portion of the configuration data.

4. The apparatus of claim 3, wherein the at least one processor is further configured to:
based on the first portion of the configuration data, identify a plurality of feature-engineering operations and determine an application sequence associated with the plurality of feature-engineering operations;
perform additional operations that apply each of the plurality of feature-engineering operations to the elements of pre-preprocessed tabular data in accordance with the determined application sequence;
generate a value of one or more features of the input dataset based on the application of the plurality of feature-engineering operations to the elements of pre-preprocessed tabular data; and
store the each of the one or more feature values at a corresponding sequential position within the input dataset.

5. The apparatus of claim 4, wherein:
the pre-processed tabular data comprises flattened tabular data; and
the first portion of the configuration data identifies each of the one or more features and specifies the corresponding sequential position.

6. The apparatus of claim 1, wherein the at least one processor is further configured to execute the instructions to:
obtain, from a second portion of the configuration data, an identifier associated with the trained machine-learning or artificial intelligence process;
based on the identifier, obtain, from the memory, a value of one or more process parameters that characterize the trained machine-learning or artificial intelligence process; and
perform additional operations that apply the trained machine-learning or artificial intelligence process in accordance with the one or more process parameter values.

7. The apparatus of claim 1, wherein the at least one processor is further configured to execute the instructions to:
based on a second portion of the configuration data, apply at least one post-processing operation to the output data; and
generate post-processed output data based on the application of the at least one post-processing operation to the output data, the response further comprising at least a portion of the post-processed output data.

8. The apparatus of claim 1, wherein:
the input dataset comprises a value of one or more features, each of the features being disposed at a corresponding sequential location within the input dataset;
the at least one processor is further configured to generate explainability data based on the application, in real-time, of the trained machine-learning or artificial intelligence process to the input dataset; and
the explainability data comprising at least one of a Shapley value, a first value of a deterministic metric, or a second value of a probabilistic metric characterizing a corresponding one of the features.

9. The apparatus of claim 8, wherein the at least one processor is further configured to execute the instructions to generate the response to the inferencing request, the response comprising the portion of the output data and at least a portion of the explainability data.

10. The apparatus of claim 1, wherein the at least one processor is further configured to execute the instructions to obtain elements of static script data from the memory, each of the elements of static script data being associated with a corresponding one of a plurality of application modules.

11. The apparatus of claim 10, wherein:
the at one processor is further configured to execute at least a subset of the plurality of application modules in accordance with respective ones of the elements of static script data; and
the executed subset of the application modules further causes the at least one process to perform the operations that (i) generate the input dataset based on an application of one or more feature-engineering operations to the elements of payload data in accordance with at least the first portion of the configuration data, and (ii) generate the output data based on the application, in real-time, of the trained machine-learning or artificial intelligence process to the input dataset.

12. The apparatus of claim 10, wherein:
the at least one processor is further configured to execute the instructions to:
receive a customization request from the computing system via the communications interface, the customization request comprising a modified first portion of the configuration data;
based on the customization request, access the configuration data within the memory and perform operations that replace the first portion with the modified first portion; and
execute at least a subset of the plurality of application modules in accordance with respective ones of the elements of static script data; and
the executed subset of the plurality of application modules further cause the at least one processor to perform additional operations that generate the input dataset in accordance with the modified first portion of the configuration data without modification to the elements of static script data.

13. A computer-implemented method, comprising:
receiving an inferencing request from a computing system using at least one processor, the inferencing request comprising elements of payload data, and the inferencing request being associated with an application, in real-time, of a trained machine-learning or artificial intelligence process to an input dataset;
based on the inferencing request, obtaining, using the at least one processor, configuration data associated with the trained machine-learning or artificial intelligence process, the configuration data being generated by the computing system;
performing operations, using the at least one processor, that (i) generate the input dataset based on an application of one or more feature-engineering operations to the elements of payload data in accordance with a first portion of the configuration data, and (ii) generate output data based on the application, in real-time, of the trained machine-learning or artificial intelligence process to the input dataset; and
transmitting, using the at least one processor, and to the computing system, a response to the inferencing request that includes at least at least a portion of the output data.

14. The computer-implemented method of claim 13, wherein:
the computer-implemented method further comprises:
obtaining, using the at least one processor, one or more elements of nested tabular data from the elements of payload data;
based on at least a second portion of the configuration data, apply at least one pre-processing operation to the one or more elements of nested tabular data, and generating, using the at least one processor, elements of pre-preprocessed tabular data based on the application of the least one pre-processing operation to the one or more elements of nested tabular data; and
performing the operations that generate the input data set comprises generating the input dataset based on an application of the one or more feature-engineering operations to the elements of pre-preprocessed tabular data in accordance with the first portion of the configuration data.

15. The computer-implemented method of claim 13, further comprising:
using the at least one processor, obtaining, from a second portion of the configuration data, an identifier associated with the trained machine-learning or artificial intelligence process;
based on the identifier, obtain, using the at least one processor, a value of one or more process parameters that characterize the trained machine-learning or artificial intelligence process from a data repository; and
performing additional operations, using the at least one processor, that apply the trained machine-learning or artificial intelligence process in accordance with the one or more process parameter values.

16. The computer-implemented method of claim 13, further comprising:
based on a second portion of the configuration data, applying at least one post-processing operation to the output data using the at least one processor; and
generating, using the at least one processor, post-processed output data based on the application of the at least one post-processing operation to the output data, the response further comprising at least a portion of the post-processed output data.

17. The computer-implemented method of claim 13, wherein:
the input dataset comprises a value of one or more features, each of the features being disposed at a corresponding sequential location within the input dataset;
the computer-implemented method further comprises generating, using the at least one processor, explainability data based on the application, in real-time, of the trained machine-learning or artificial intelligence process to the input dataset; and
the explainability data comprising at least one of a Shapley value, a first value of a deterministic metric, or a second value of a probabilistic metric characterizing a corresponding one of the features, the response comprising the portion of the output data and at least a portion of the explainability data.

18. The computer-implemented method of claim 13, wherein:
the computer-implemented method further comprises:
obtaining, using the at least one processor, elements of static script data from a data repositoryly, each of the elements of static script data being associated with a corresponding one of a plurality of application modules; and
using the at least one processor, executing at least a subset of the plurality of application modules in accordance with respective ones of the elements of static script data; and
the executed subset of the application modules further causes the at least one process to perform the operations that (i) generate the input dataset based on an application of one or more feature-engineering operations to the elements of payload data in accordance with at least the first portion of the configuration data, and (ii) generate the output data based on the application, in real-time, of the trained machine-learning or artificial intelligence process to the input dataset.

19. The computer-implemented method of claim 18, wherein:
the computer-implemented method further comprises:
receiving a customization request from the computing system using the at least one processor, the customization request comprising a modified first portion of the configuration data;
based on the customization request, accessing, using the at least one processor, the configuration data within a data repository and performing operations, using the at least one processor, that replace the first portion with the modified first portion within the data repository; and
the executed subset of the application modules further causes the at least one process to perform the operations that generate the input dataset in accordance with the modified first portion of the configuration data and without modification to the elements of static script data.

20. A tangible, non-transitory computer-readable medium storing instructions that, when executed by at least one processor, cause the at least one processor to perform a method, comprising:
receiving an inferencing request from a computing system, the inferencing request comprising elements of payload data, and the inferencing request being associated with an application, in real-time, of a trained machine-learning or artificial intelligence process to an input dataset;
based on the inferencing request, obtaining configuration data associated with the trained machine-learning or artificial intelligence process, the configuration data being generated by the computing system;
performing operations that (i) generate the input dataset based on an application of one or more feature-engineering operations to the elements of payload data in accordance with the configuration data, and (ii) generate output data based on the application, in real-time, of the trained machine-learning or artificial intelligence process to the input dataset; and
transmitting, to the computing system, a response to the inferencing request that includes at least at least a portion of the output data.
